(19) United States
(12) Patent Application Publication
(10) Pub. No.: US 2014/0358678 A1
(43) Pub. Date: Dec. 4, 2014

(54) SYSTEM AND METHOD FOR CLICK FRAUD PROTECTION

(71) Applicants: Simon Raab, Santa Barbara, CA (US); Timothy S. Rodgers, Santa Barbara, CA (US); Matthew Kauffman, Santa Barbara, CA (US)

(72) Inventors: Simon Raab, Santa Barbara, CA (US); Timothy S. Rodgers, Santa Barbara, CA (US); Matthew Kauffman, Santa Barbara, CA (US)

(21) Appl. No.: 14/458,739

(22) Filed: Aug. 13, 2014

Related U.S. Application Data
(63) Continuation-in-part of application No. 14/082,872, filed on Nov. 18, 2013.
Application No. 14/082,872 is a continuation-in-part of application No. 14/265,789, filed on Apr. 30, 2014.
Application No. 14/265,789 is a continuation-in-part of application No. 14/355,318, filed on Apr. 30, 2014.
Application No. 14/355,318 is a continuation-in-part of application No. PCT/US12/62163, filed on Oct. 26, 2012.
Application No. PCT/US12/62163 is a continuation-in-part of application No. 13/551,981, filed on Jul. 18, 2012.
(60) Provisional application No. 62/009,413, filed on Jun. 9, 2014.
(60) Provisional application No. 61/938,321, filed on Feb. 11, 2014.

(51) Int. Cl. G06Q 30/02

(52) U.S. Cl. CPC G06Q 30/0248
USPC 705/14.47

(57) ABSTRACT

A system and method for preventing click fraud and/or determining invalid clicks are provided to measure click related data, decide according to target URL defined conditions whether to present an Intelligent interstitial, decide according to target URL defined conditions how to populate the interstitial and then measure Search user interaction with the interstitial.

### CROSS REFERENCE TO RELATED APPLICATIONS

This application claims the benefit of U.S. Provisional Application No. 62/009,413 filed Jun. 9, 2014; and, U.S. Provisional Application No. 61/938,321 filed Feb. 11, 2014; and is a Continuation-In-Part of U.S. patent application Ser. No. 14/082,872 filed Nov. 18, 2013; which is a Continuation-In-Part of U.S. patent application Ser. No. 14/265,789 filed Apr. 30, 2014; which is a Continuation-In-Part of U.S. patent application Ser. No. 14/355,318 filed Oct. 26, 2012; which is a Continuation-In-Part of PCT Application No. PCT/US12/62163 filed Oct. 26, 2012, which is a Continuation-In-Part of U.S. patent application Ser. No. 13/551,981 filed Jul. 18, 2012, which claim the benefit of priority of U.S. Provisional Application No. 61/553,291 filed Oct. 31, 2011, the disclosure of which is incorporated by reference herein in its entirety

### BACKGROUND

The present disclosure relates to a system and method for protecting against invalid clicks in online advertising relationships.

Pay per click (PPC) (also called Cost Per Click (CPC)) is an Internet advertising model used to direct traffic to websites, where advertisers pay the publisher when the ad is clicked, constituting a transaction. Pay Per Click advertisers typically bid on keyword(s) relevant to their target market from Search Companies and other publishers. Publishing sites commonly charge an advertiser a fixed price per click or use a bidding system. PPC “display” or “affiliate” advertisements are shown on web sites with related content that have agreed to show ads. These approaches differ from the “pay per impression” methods traditionally used in television, newspaper advertising and some online advertising by offering a pay for performance model with the click being the measure.

In contrast to the generalized web portal, which seeks to drive a high volume of traffic to one site and monetizing that traffic based on impressions delivered, PPC implements the so-called affiliate model, which provides purchase opportunities at a variety of points of presence on the Internet and its multitude of mediums. It does this by offering financial incentives (in the form of a percentage of revenue derived from the advertiser) to affiliated partner sites. The publisher provides, directly or indirectly, purchase-point click-through to the advertiser. It is a pay-for-performance model: If a publisher does not generate sales in the form of a click, it represents no cost to the advertiser. Variations include banner exchanges, pay-per-click, cost per action and revenue sharing programs.

Search engines and affiliated Websites that utilize PPC ads display an advertisement when a keyword query matches an advertiser's keyword list, or when a content site displays relevant content. Such advertisements may be called sponsored links or sponsored ads, and generally appear adjacent to, above organic search results on search engine query results pages, or anywhere a web developer chooses to implement them on a content site, even working it within site and multimedia content.

Among PPC providers, Google AdWords, Yahoo! Search Marketing, and Microsoft adCenter are the three largest network operators, and all three utilize a bid-based model.

Although the aforementioned providers and others purport to have implemented automated systems to guard against abusive clicks by competitors or corrupt web developers, the PPC advertising model is open to abuse through invalid clicks and subsequent monetary gain.

Prior to the advent of pay-per-click (PPC) advertising, the threat of invalid clicks was very limited. However techniques similar to those used to conduct invalid clicks were being used to inflate page views since advertisers paid by impressions rather than specific performance of the user action.

Invalid clicks are generally defined as any paid-for click that originates in a malicious attempt to drain an advertiser's budget. This form of Internet based fraud occurs in pay-per-click online advertising when a person, automated script or computer program imitates a legitimate user behavior, by clicking on an ad, for the purpose of generating a charge per click without having actual interest in the target of the ad's link other than to monetize the click transaction. Click fraud is the subject of some controversy and increasing litigation due to the advertising networks being a key beneficiary of the fraud, along with the perpetrator of the crime.

Pay per-click advertising or, PPC advertising, is an arrangement in which publishers (as operators of Web sites or Networks), display clickable links for advertisers in exchange for a charge per click fee. As this industry evolved, a number of advertising networks developed, which act as middlemen between these two groups (publishers and advertisers). Each time a (believed to be) valid Web user clicks on an ad, the advertiser pays the advertising network, which in turn pays the publisher a share of this money. This revenue-sharing system is seen as an incentive for invalid click transactions.

The largest of the advertising networks, Google's AdWords/AdSense and Yahoo! Search Marketing, act in a dual role, since they are also publishers themselves (on their search engine query results pages). According to critics, this complex relationship may create a conflict of interest. For instance, Google loses money to undetected invalid clicks when it pays out to the publisher, but it makes more money when it collects fees from the advertiser. Because of the spread between what Google collects and what Google pays out, invalid clicks directly and invisibly profits Google. Opinions widely vary with regard to the amount of revenue that is generated by invalid clicks. However, it is believed that if this form of click fraud were completely eliminated, all of the major PPC engines would suffer a significant blow to revenues and share prices. It is important, however, that these PPC companies realize that maintaining the trust of their advertisers is vital to the long-term health and viability of the industry.

A rising number of companies would agree. The percentage of advertisers listing click fraud as a “serious” problem, tripled in 2005, to 16%. This is according to a survey by the Search Engine Marketing Professional Organization. Advertisers have filed at least two class-action suits saying Google, Yahoo, and other search engines ought to be more up-front about methods for combating invalid clicks.

The impact of online fraud, resulting in invalid clicks, will only increase as advertisers devote more of their budgets to Internet advertising, where the aggregate expense of advertising is proportional to the frequency of clicks. The more times an ad is clicked, the greater the advertising expense. As the competitive landscape increases for these advertisements, costs will rise and it will only become more expensive and impactful to advertisers.

Most PPC search engines have systems in place that identify click fraud and then subsequently, do not charge the advertiser for the fraudulent clicks. Google, the largest PPC-driven engine, seems to be able to detect rapid, successive clicking from the same person or IP address. However, individuals or organizations conducting click fraud are using ever more advanced cloaking technologies that may circumvent these preventive systems. Unfortunately, these networks cannot detect these events until after they have been committed for a period of time and are highly reactionary to the crime.

The PPC search market is currently dominated by 3 companies comprising over 95% of domestic paid search namely, Google, Yahoo and Bing. Google is by far the largest of the three. The Google PPC philosophies and invalid click protection methodologies are dominant and typical to the industry. Hence, Google related PPC activities will be used here in to characterize the PPC search industry mechanics and behavior. Google says that they strive to weed out all kinds of illegitimate traffic. To stop click fraud, Google uses software to scour Web traffic through its ads for repeated clicks, click through rates, conversion rates, organized click rings, unusual patterns, and visits from anonymous and overseas proxy servers and other non disclosed methods.

For search engine detection and filtering techniques, each click on an ad is examined by the search engine system. The search engine company looks at numerous data points for each click, including the IP address, the time of the click, any duplicate clicks, click origin, conversion rates and various other click patterns. The system then analyzes these factors to try to isolate and filter out potentially invalid clicks before they ever reach an advertiser's account reports. They will also retroactively credit the account if the invalid click is detected post event. They do not describe the event or explain the credit. This detection and filtering occurs over a number of levels including the following: real-time systems filter out activity fitting a profile of invalid behavior (such as excessively repetitive clicks); and clicks and impressions from known sources of invalid activity are automatically discarded.

In advanced monitoring techniques, various unique and innovative methods are applied at each stage of the filtering process, thereby maximizing proactive detection of invalid activity. The search engine companies claim that they constantly improve their monitoring technology, enhancing filters, and examining a growing set of signals. In addition to automated click protection techniques, an invalid click protection team at Google uses specialized tools and techniques to examine individual instances of invalid clicks. When the system detects potentially invalid clicks, a member of this team examines the affected account to glean important data about the source of the potentially invalid clicks. One of the goals of the Google team is to make invalid activity very difficult and unrewarding for unethical users, thereby decreasing their chance of success. They also rely on the advertisers themselves to bring suspicious behaviors to their attention by requesting reimbursement. However they are very reluctant to give reimbursements for fraudulent behavior and tend to take a “trust us” attitude.

However, despite these extensive claims Google has settled a number of click fraud lawsuits in favor of the plaintiffs and agreed to independent review of their claims described above. Dr. Alexander Tuzhilin, an independent expert who has examined the Google detection methods, policies, practices, and procedures, has documented these and other details of their monitoring system. (See http://docs.google.com/viewer?url=http://googleblog.blogspot.com/pdf/Tuzhilin_Report.pdf).

Additionally, Google as with other search companies, do not reveal specifics of their click counting methodologies nor do they report click specific information as recommended by the Interactive Advertising Board (IAB) recommended standards for counting pay-per-clicks and reporting to the advertisers. (See http://www.iab.net/iab_products_and_industry_services/508676/guidelines/clickmeasurementguidelines).

There are various inadequacies of search engine self-policing, and critics contend that such secrecy is problematic, because Google and its competitors also make money on fraudulent clicks and invalid clicks. Here's how it works: Hundreds of thousands of advertisers that market on Google's search engine also let Google distribute their ads to other Web sites (also known as the Display Network). When an ad is clicked on a partner site, both Google and the Web site operator split the revenue charged to the advertiser for the transaction. If such a click is bogus, and gets through the search company's filters, Google still profits, at least in the short run—leaving some in the industry suspicious of its motivations and efforts to combat fraud. Whatever the reason, the silence makes a prosecutors' jobs harder. In order to prove charges stemming from extortion and click fraud, legal experts say Google would have to pull back the curtain on how it quantifies and grapples with the issue. For instance, prosecutors trying to prove click fraud would have to show specifically how and why clicks were deemed fraudulent.

The Inventors further contend that the Search Engine Companies contribute to the potential for invalid high paying click through a phenomenon called Search Disparity. Search Disparity is the disparity between the advertisers paid keyword(s) purchased and the keyword(s) searched by the user of the search service. The presentation of the higher paying advertisers' keyword(s) with high disparity between the searched terms and the search results encourages invalid clicks because of the users assumed confidence that the Search Engine is returning valid impressions strongly related to the original query and the targeted intent of the advertiser.

The user will click the impression causing a paid click event only to find that the advertiser link is poorly related to the user query at which time the user will typically hit the back button or other available navigation means to return to the original search results. However, by that time the click has been charged. This process will be repeated as the user blindly clicks on other impressions on the search page looking for something relevant to the original query, resulting in multiple transactions from a singular search query. Manipulated disparity between user searched keywords and advertiser's intended keyword(s) promotes the presentation of less relevant but higher-revenue based paid keyword(s) advertisements. This also allows Google to attribute higher paying keyword(s) to lesser paying keyword(s) and benefit monetarily from this disparity. The inventors have reason to believe that Search Disparity has the potential to be actively manipulated by the Search engine companies in order to meet short term business and revenue goals. Further, Search Engine Companies also assign a “Quality Score” with the associated advertisers' keyword(s). The quality score is largely unrelated to the target URL for the advertisement from the advertiser's perspective but has more to do with the resulting revenue to the search engine company. This is largely the percentage of impressions to clicks ratio that determines the price that an advertiser might have to pay per click. The lower the quality score, the higher the bid the advertiser must pay to compete. This accomplishes two things, increases revenue-per-click and puts upward pressure on price-per-click for any given keyword(s). It does not add any value to the advertiser, in fact, it forces the advertiser to create “clicky” or higher conversion ads and to the detriment of the effectiveness of their advertising spend. This use of the keyword(s) in the limited space provided creates in inverse proportion between quality and quantity of clicks. Search engines can and do adjust quality scores to meet their revenue requirements, effectively forcing advertisers to pay more for less.

Perhaps most importantly, Google does not let the advertiser know how much, on a per transaction basis (click), the user was charged for the click or allow the user to determine the validity of that transaction. In essence, you do not know what you bought, how much each click definitively cost, the disparity of the associated terms and resulting value to your site for each transaction or click.

Third party platforms claim to provide relief from invalid clicks for ad networks and their advertisers, with the added benefit of detailed click scoring for managing traffic quality. Claiming to be an independent and unbiased 3rd party allows data to be presented to the Search Engine Company in an effort to claim credits for invalid clicks.

Click fraud protection companies use sophisticated algorithms and intelligence from advertisers to identify the vast majority of invalid or fraudulent clicks and scores. These companies determine invalid clicks by analyzing the attributes of every single click to score click traffic in real-time. The assigned score classifies traffic along a spectrum of click quality from invalid to high conversion rates. Since each click is evaluated individually, scores can be aggregated to provide views of traffic along various sources and destination dimensions, including: click, site, publisher, network, geography and more.

The resulting scores and related click data are available via both a web-based reporting interface and a powerful API's. Generally such services allows for integration into an ad networks existing systems, providing insights to assist in real-time decision-making and traffic optimization for maximized profitability.

Search Engine Companies such as Google have however resisted acknowledging a majority of the claims or credits of such invalid click protection companies claiming that their click counting and invalidity parameters were inaccurate. However, they do not allow for the auditing of fraud on a per transaction or click basis, but return all reporting in aggregate as to obfuscate data. In fact, refunds are issued for detected fraud without any explanation of which terms were used or rational for it. This prevents the advertiser from safeguarding themselves against the threat. Google does provide very limited tools such as negative keywords and site blocking ability, but this requires a high level of sophistication from the advertiser and does not insure against bad behavior and invalid clicks. In the final analysis the Search Engine Company's claim that once the user is redirected to the advertiser's URL that their job is done and that user behavior on the site is inaccessible to them. This is intended to absolve them of determining invalid clicks through behavior, such as bounce rates, back traffic, time on site and page views. Interestingly, companies like Google provide access to tools such as Google analytics, which do not provide the time on site and page view behavior data for each click, or per transaction, but only in aggregate. This missing link makes it impossible for an advertiser to make specific claims of invalidity of a click or “bounce” as it is commonly referred to unless a 3^{rd} party service is used. The inventors strongly suspect that the Search Engine Companies are complicit in limitations in providing this information and subsequent increase in invalid high-cost clicks because the reporting and credit process is obscure and lacks detailed reporting except in part for the very large accounts with high visibility.

Invalid clicks are a dizzying collection of scams and deceptions that inflate advertising bills for all companies of all sizes. Click Fraud is a perpetual nuisance for online advertisers, is usually hard to detect in the moment, but clearly evident after the fact. That's because, unlike real clicks, sham clicks performed by automatic click software or human driven elements pump up an advertiser's pay-per-click (PPC) fees, but never generate sales or real conversion opportunities. Other clicks are non-malicious, but nonetheless invalid, such as accidental clicks or repetitive clicks by the same user on the same advertisement. Under the existing construct, advertisers are required to effectively catch invalid clicks without being allowed access to the derivation of the click, context of the click, auditing rights to the specific click or other data from the search engine company, but must supply click specific information in order to obtain a refund. In fact, without third party or internal proprietary products, it would be virtually impossible to detect invalid clicks and search engines would have free reign to inflate revenues by the aforementioned means keyword disparity, irrelevant display placements and conversion scams.

A pay-per-click advertising system can be abused in several ways. In one type of click fraud, an advertiser will click a competitor's ad with the intention of “maxing out” their competitor's allocated budget. Once their competitor's budget has been exhausted, their ads may exclusively be shown to legitimate users. Such an attack ends up wasting the competitor's financial resources, and allows the attacker to receive all the clicks that their competitor might have otherwise received. In another type of click fraud, a web site publisher will click on ads shown on their own web site, or other friendly sites, in an attempt to receive the revenue share for those clicks or create revenue for others. Some operators act as a “publisher” and created several “doorway sites” that contain links that eventually led to ads on which the automated or friendly volunteers would click.

To avoid detection, attackers have become more sophisticated, using a variety of techniques, including proxy servers, malware, DNS hijacks, cookie stuffing, click ring networks and multiple ISPs to generate fraudulent clicks from different IP or masked addresses. Many of these attackers have simply recruited networks of individuals to click on various ads within their network for a share in the profits. Users are instructed to click on different ads at different times or simply serve invalid impressions to counter internal or elude detection. Most PPC search engines have systems in place that identify click fraud and then subsequently do not charge or credit the advertiser for the fraudulent clicks. However, individuals or organizations conducting click fraud are using more advanced cloaking technologies that may circumvent these preventive systems. Further because of the huge conflicts of interest in the PPC model the Search Engine Companies are likely to be complicit in the problem by encouraging revenue enhancing behavior internally and in affiliates and hence making only nominal public attempts to limit invalid clicks sufficient to claim the ethical high-ground while simultaneously looking the other way for large quantities of invalid clicks representing billions of dollars in revenue.

The invalid or fraudulent clicks can come from a number of sources. A first source may be individuals deploying automated clicking programs or software applications (called bots) specifically designed to click on ads, and mask origin. Further, individuals might employ low-cost workers or incentivize others to click on the advertising links. Other sources include publishers manually clicking on the ads on their pages, publishers manipulating web pages in such a way that user interactions with the web site result in inadvertent clicks, or publishers subscribing to paid traffic websites that artificially bring extra traffic to the site, including extra clicking on the ads and the purchase of redirected back traffic. Also, as mentioned above, advertisers may manually click on the ads of their competitors.

Other sources include publishers being sabotaged by their competitors or other ill-wishers, various types of unintentional clicks, such as double clicks, or customers getting confused and unintentionally clicking on the ad without a malicious intent. Invalid clicks may also stem from technical problems, system implementation errors and coordination activities, resulting in double-counting errors. Additional sources include multiple accounts of AdSense publishers, wherein some AdSense publishers illegally open “new” accounts under different names and using false identities.

All the clicks originated from these illegal accounts are considered invalid. Use of rolling-IP distributed attacks from multiple countries. In addition, organized human click-fraud campaigns using low-cost third-world labor.

On Google, “impression fraud” is another equally problematic form of click fraud. Impression fraud occurs when criminals manipulate the number of page impressions for a given search term. When an advertiser's relative click-through rate (CTR) decreases, his or her search term can be suspended because of low CTR performance or quality score. This creates a window of opportunity for other advertisers. By committing impression fraud, they are able to obtain higher search rankings at lower costs due to the crippled competition.

Domain Parking, referring clicks from web pages that were automatically generated by the Search Engine Companies that included paid ads, as well as links to other related domain name pages with still more ads. These referring web pages created directly by the publishers or by companies owned by the affiliates.

What is needed in the art is an improved method of protecting against invalid and fraudulent clicks.

### SUMMARY

The above described problems and disadvantages in the art are overcome or alleviated by the present system and method for invalid and fraudulent click detection and prevention, including: monitoring user interaction with a click validation web page that includes advertising with at least one clickable link; determining whether a user click-through of said clickable link is legitimate or whether said click-through represents an imitation of a legitimate user click-through by measuring and extracting user data from click transactions, interaction with an interstitial and optionally, where appropriate, behavior on the target URL and subsequent pages, amounting to plural disparate sources and comparing said user data to determine the validity of the click-through.

Exemplary systems and methods for preventing click fraud and/or determining invalid clicks are provided to measure click related data, decide according to target URL defined conditions whether to present an Intelligent interstitial, decide according to target URL defined conditions how to populate the interstitial and then measure Search user interaction with the interstitial. Other exemplary embodiments use target URL defined conditions of interstitial interaction to determine click validity and in the event of a valid click continuing to the target URL and optionally measuring on-site behavior. Further exemplary embodiments measure data from an original click, observe interstitial behavior and optionally merge target URL website measured behavior into a database providing user data for each individual click. Other exemplary embodiments generate reports specific to seeking credits for payments on invalid clicks and other website intelligence.

Thus, the present invention advantageously avoids prior problems with preventing click fraud. In exemplary embodiments, such system uses compiled data to determine and or identify multiple click transactions from a single user as potential click fraud, which data may be compared against other data from the compilation of the two disparate sources and clicks in aggregate. Further, exemplary embodiments of the present invention facilitate assignment of a disparity score of a purchased keyword versus search keyword(s) phrases and associations made, including synonyms. Other exemplary embodiments provide for the use of the collected information to establish affiliate relationships between two parties, where the click is the transaction event and the event payment is determined by the actions of the delivery of the click, and the behavior on site determines and qualifies the amount to be paid for the transaction.

Other exemplary embodiments provide for the use of recorded behavioral actions on a site from an original keyword searched to determine algorithmically the relevancy of the search term to the landing page and subsequent ranking of the site for future search results. Exemplary embodiments also provide for the use of a browser based code, e.g., JavaScript, etc., to report back page views and time on site, allowing correlating of that data back to a singular keyword/click of origin. This data is reported back to the database prior to the user closing the browser, utilizing browser navigation or other native available actions.

Further, exemplary embodiments provide for use of data collected to tie back that information to determine the quality of the referring site e.g. display network, affiliate, and search syndicated partner, to the landing site from origin source. In other exemplary embodiments, a paid keyword is compared against associated search keywords or words to determine a relevancy for the determination of validity and value of a search based click transaction.

In other exemplary embodiments, the time on site attributed to an individual user on a landing page and subsequent pages are tracked and tied back to a singular click transaction. Further exemplary embodiments provide for activation of a doorman interstitial, which is populated with search disparity information and activated by conditions set by the destination URL vendor, which provides a final defense against Search Engine Company caused disparity-fraud, robotic clicking and other nefarious activity.

Embodiments of the present invention also provide the ability to track time on a doorman/interstitial prior to action by a user or bot and to correlate that action and time to the choice presented and linking that information to continued destination URL activity and transaction record. Other exemplary embodiments provide the ability to repopulate the original search term for monetization after the traffic has been paid for once the doorman has been displayed.

Exemplary embodiments also provide for the display of interstitial activated by a Mouse-over event on the original search page. For example, a doorman display and validity of a PPC ad could be displayed with or without clicking. This could be presented as a search engine results page improved feature to obviate an exemplary interstitial provider click-to-interstitial model.

Further exemplary embodiments also provide for the determination of disparity between the search terms and the PPC ad keywords using a Match Quality Score (hereinafter referred to as “MQS”) formula based calculation, based on a variety of word, grammar and context related factors. The MQS may be used in combination with continuation rates from User behavior to demonstrate poor quality impressions by the search engine company and justifying refunds. The accuracy of the Match Quality Score may be enhanced through correlation to the doorman continuation rates such that the MQS is linearly related to the actual continuation rates.

Additional exemplary embodiments also provide for the Match Quality Score to be improved by using all the keywords in use by the advertiser together rather than individually to improve the relationship between very broad search terms and the detailed advertiser product line. Broad search terms allow the inaccurate presentation and increased costly impressions of the PPC ads unless further comparisons to known company keywords are made.

Exemplary embodiments also provide for the optimizing of affiliate relationships by determining affiliates providing impressions of the advertiser PPC ads which results in high MQS and high continuation rates and providing a process for direct advertising relationships between effective affiliates and the advertisers which exclude the search engines with an attendant significant reduction in advertising costs.

Further exemplary embodiments provide for the repopulation of the search term and search results rejected by the user at the doorman. The intelligent interstitial provider may then populate a new affiliate search result page with improved MQS and thereby generate advertising revenue for the doorman provider and better continuation rates for the advertiser.

In other exemplary embodiments, a doorman may operate as a greeter, rather than, or in addition to operating in a defensive role. An exemplary doorman greeter may provide additional information and provide directions to locations in a website through a soft landing on a more relevant site location as a function of, e.g., user interests.

Exemplary embodiments also provide for improved doorman information in the form of multi-media information, coupons etc. as a function of the search terms, which enhance the user knowledge and ensure higher continuation rates and better on site behavior subsequent to the doorman. The doorman can direct the search user to the most relevant location within the target URL instead of simple landing on the home page.

Additional exemplary embodiments also provide for accumulating information on the behavior of users which allows improved presentation of advertisements as a function of behavior versus search terms and PPC ad keywords. This information results in an improved search engine functionality, which generates higher continuation rates by allowing the users to transparently qualify the search results.

Additional exemplary embodiments provide for the avoidance of inadvertent clicks on mobile devices due to inaccurate finger placement. The doorman can provide a simple option to avoid unnecessarily transitioning to an advertiser web page.

Other exemplary embodiments provide for the pass-through of relevant campaign target URL click information to the target URL in the event of a continuation in order to allow server side tracking software to perform correctly. The doorman thereby does not create a barrier to conventional on-site tracking software.

Further exemplary embodiments provide for the tracking of times on site after continuing from the doorman to the target URL without on site server side software. The doorman captures the time the doorman is left to the time the user returns to the doorman through the common use of the “back” button to exit the advertiser's site.

Other exemplary embodiments provide for the server side installation on the target URL site of doorman Code providing enhanced direct control over defender and/or greeter features of the doorman.

The above discussed and other features and advantages of the present invention will be appreciated and understood by those skilled in the art from the following detailed description and drawings.

### BRIEF DESCRIPTION OF THE DRAWINGS

Referring now to the drawings, wherein like elements are numbered alike in the following FIGURES:

FIG. 1 is an exemplary workflow for click validity, including exemplary data collection and storage;

FIG. 2 is a flowchart showing doorman interstitial activation flow, including exemplary doorman auto-configuration, presentation and search user interrogation flow;

FIG. 3 is a screenshot showing a doorman interstitial;

FIG. 4 is a flowchart showing a classical PPC business model;

FIG. 5 is a flowchart showing an exemplary II/provider relationship setup;

FIG. 6 is a flowchart showing an exemplary improved PPC business model;

FIG. 7 is a screenshot showing exemplary doorman elements;

FIG. 8 is a screenshot showing an exemplary doorman that is on a greyed out target homepage;

FIG. 9 is a screenshot showing exemplary doorman known keywords;

FIG. 10 is a screenshot showing exemplary doorman unknown keywords;

FIG. 11 is a screenshot showing an exemplary interface for a doorman repeat user;

FIG. 12 is a screenshot showing an exemplary doorman with an affiliate link;

FIG. 13 is a flowchart showing exemplary doorman behavior and data flow;

FIG. 14 is a flowchart showing an exemplary doorman utilizing mouse over on a publisher site;

FIG. 15 is a flowchart showing an exemplary doorman hosted on a target URL;

FIG. 16 is an exemplary doorman with a promotional greeting and match options;

FIG. 17 is an exemplary doorman with site search input fields;

FIG. 18 is an exemplary doorman with invisible clickbot decoys;

FIG. 19 is an exemplary doorman with a search engine migration button;

FIG. 20 is an exemplary illustration of an improved PPC ad placement using doorman data;

FIG. 21 is an exemplary doorman utilized with an improved renumeration model;

FIG. 22 illustrates an exemplary mobile doorman deployment;

FIG. 23 is an exemplary user interface with deployment of a doorman on a background image of a target URL; and

FIG. 24 is an exemplary user interface with a 1-click Captcha-type security feature.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be further understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, components and/or groups, but do not preclude the presence or addition of one or more other features, integers, steps, operations, elements, components, and/or groups thereof.

It will also be understood that the terms “photo,” “photograph,” “image,” “screen shot” or any variation thereof may be interchangeable. Thus, any form of graphical image may be applicable to example embodiments.

It will also be understood that the terms “statistics,” “measurements,” “analytics,” “calculations,” or other similar terms may be used to describe example forms of the associated definitions as understood by one of ordinary skill in the art, although other similar acts/functions may be applicable depending upon any particular form of an example embodiment. For example, a statistical calculation may include analytical calculations, and vice versa. Furthermore, measurements may include calculations upon, during, subsequent, or in addition to measurements or any act of retrieving data.

It should also be understood that other terms used herein may be applicable based upon any associated definition as understood by one of ordinary skill in the art, although other meanings may be applicable depending upon the particular context in which terms are used.

Therefore, the terminology used herein is for the purpose of describing particular embodiments only and is not intended to be limiting of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

As has been described above, the present disclosure provides a system and method for protecting against invalid and fraudulent clicks as well as validating clicks using the same processes. In exemplary embodiments, the system and method utilizes code to measure and extract Internet user data from two or more disparate sources in a click path and reports it back to an aggregating database to accurately determine the validity of measured traffic, the time and user action taken on the Interstitial, the number of page views and time on site in whole or in aggregate in paid or unpaid in click relationships. This information may be used to: audit existing click traffic; validate and invalidate clicks based on user behavior, establish contractual relationships where behavior determines value of traffic and clicks can be treated as a singular and/or serial events where value can be determined from the measurement of data and applied retroactively to the occurrence; determine quality and relevancy of search from user behavior; fraud detection; configure and activate a “doorman” as preventive measure to defend against click fraud, validating clicks, assigning proportional value and remuneration to click transactions based on user behavior other click parameters and provide “greeter” functionality to improve continuation behavior.

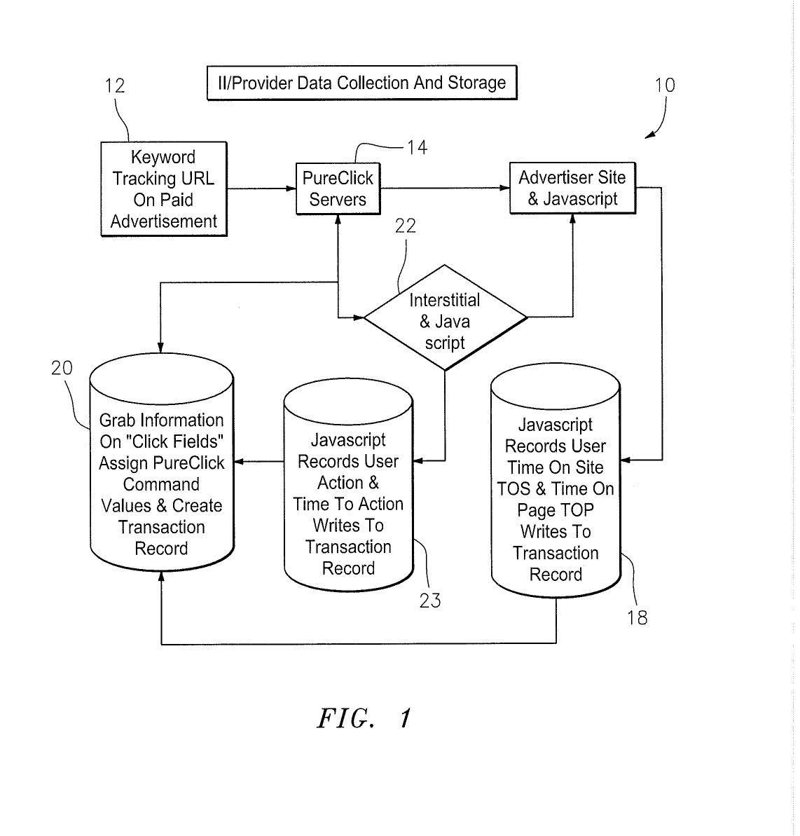

Reference is made to FIG. 1, which shows a click validity methodology and workflow generally at 10. The workflow represents the accurate combining of the two disparate sets of data to create a browser based transaction record for individual clicks to allow for the auditing of individual clicks. This combining of data can be used to activate a final vendor and a user driven/vendor-site-entrance doorman. The doorman is an interstitial, which is interposed between the vendor site and the navigating user, and provides an unassailable final determinant of the quality of the click as well as full defense against most known forms of click fraud and validating the click intention. The interstitial is served up in the linear click path and is not a PopUp or PopUnder, but is, if served, an integral part of the click path and a necessary component to continue to the target URL.

Referring still to FIG. 1, the exemplary basic workflow begins with tracking of user keywords or URL clicks, 12 via a tracking service 14. The process 10 includes analysis of the advertiser site and Exemplary Javascript code 16, and a review of JavaScript records, including Time on Site (TOS) and Time on Page (TOP) data 18. Exemplary JavaScript may also record from the interstitial 22 user action and time to action 23. The tracking service may also utilize information on click fields in assigning tracking values 20. As described above, the process also includes one or more interstitials 22 between the vendor site and the user whose content is based on click characteristics, serial relationships, keywords, origin URL, business relationships and other known behaviors and content.

The workflow represents a three step process by which the data from two different sources are tracked and collected for the purpose of optionally aggregating two disparate sets of data to determine behaviors and actions of a single user click event, where first user packet information is recorded and stored on a server and where subsequent user behaviors of time on interstitial, action on interstitial, time on site, inclusive of landing page, back button use and time and individual page views are recorded in a Browser based JavaScript (see fields 16 and 18 in FIG. 1) and transmitted and attributed back to the original event. The result is the compilation of data to accurately reflect click behavior by looking at singular transactions. While the exemplary embodiments of the present disclosure refer to specific types of code, e.g., JavaScript, it should be recognized that other types of code providing the same or similar results are contemplated herein.

The PureClick Server Tracking URL contains link specific information and redirects the URL to land on a targeted page with JavaScript enabled. The information collected via JavaScript is then used to activate and populate an interstitial 22 known as the doorman as a final determinant of click validity along with other methods. In exemplary embodiments, the doorman presents information on disparity in the form of the Match Quality Score or simply by providing the user's search terms and the paid keywords of the advertiser's ad and requires an actual search user's response so as to provide a defense against automated click fraud and measures click validity prior to redirecting to the target URL.

The first step includes initial collection of available raw data to accurately determine a single user click. This data is collected intermediately on the PureClick Server as the user passes from one site to another and is recorded in a database. Exemplary data includes the establishment of a transaction ID, the time or date stamp of the click, the IP address, the user agent, a cookie, the referring URL, such as a primary referring URL or an originating URL, and keywords.

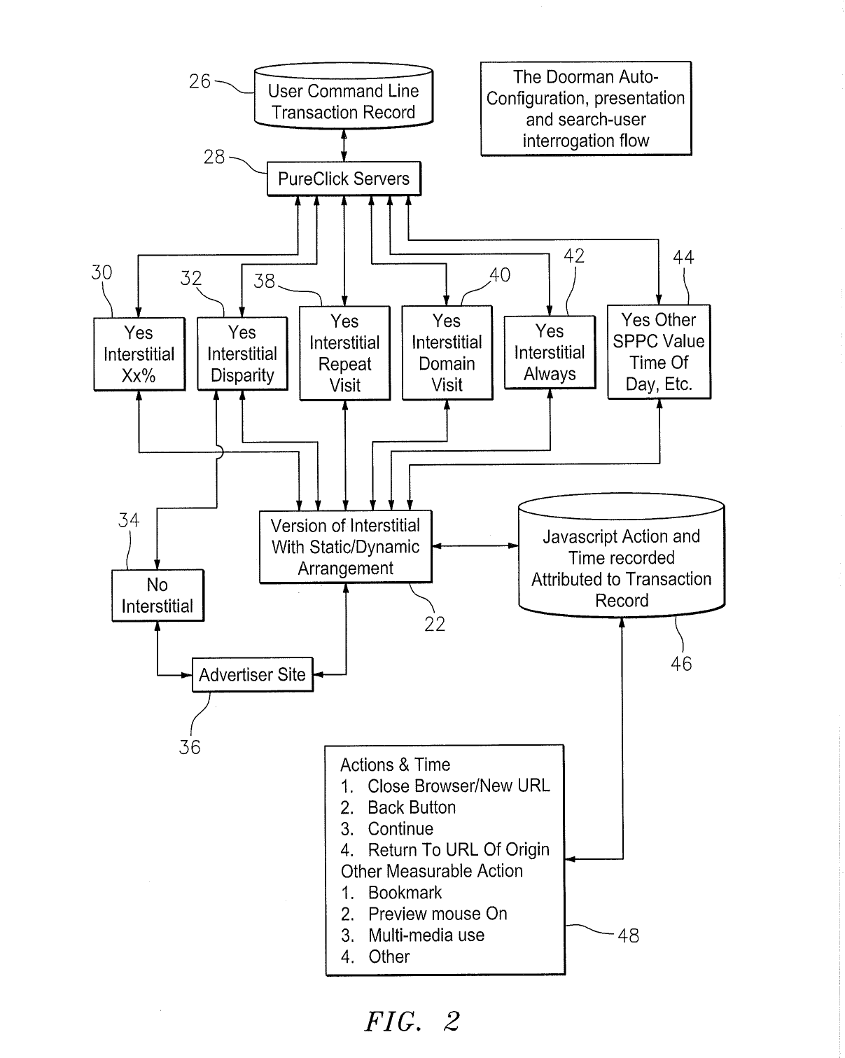

As previously discussed the inventors believe that the Search Engine Companies may be complicit through internal fraud with external sources of fraud. The doorman may thus be configured as a welcome box, which appears under certain predetermined conditions. These conditions are set by the advertiser or target URL as instructions to the doorman as shown in FIG. 2.

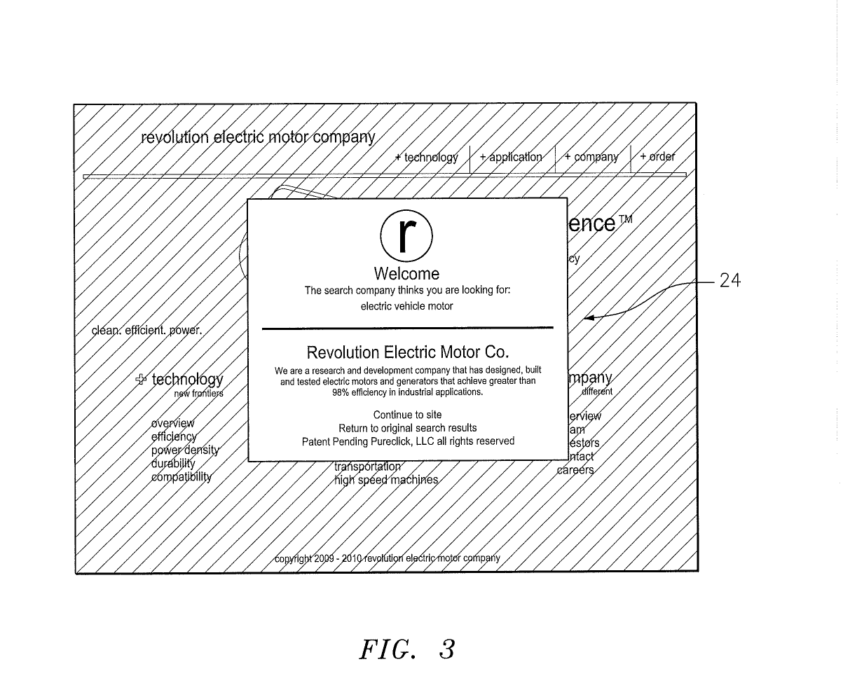

In the event that the doorman presentation conditions are met then the doorman Interstitial appears with a simple welcome and access enquiry, as is shown generally at 24 in FIG. 3.

Referring again to FIG. 2, various exemplary triggers for the interstitial (22 in FIG. 1), include random triggers for the interstitial, user-based triggers, time of day based triggers, business relationship triggers, location based triggers, triggers activated for repeat visits, IP based triggers, search engine disparity based triggers, dollar value per click based triggers and bot protection based triggers (with manual input or random positioning). Such trigger, when activated at pursuant to proper trigger conditions generates the interstitial 22. If the trigger is not activated, the interstitial 22 is not activated, and the user is directed to the customer site. Such trigger may be determined after an ID is assigned relative to search results or user interaction (such as forward or backward navigation or bookmarking).

FIG. 2 illustrates a Keyword Tracking URL on Advertisement 26 passing to a doorman (PureClick) server 28. Various triggers provide for an interstitial 22 (which as will be discussed in further detail below, may be static or dynamic in arrangement), such as Xx % of the time 30, Match Quality Score for disparity 32 (though depending on the disparity value, an interstitial 22 may not be triggered 34, dependent upon the disparity value relative to an advertiser site 36), repeat visit 38, specific domain visit 40, relationship (“Always”) 42, and other $PPC values 44, such as time of day, any of the above, etc.

Where an interstitial is triggered, in a second step, data may be collected from JavaScript on the doorman 46, landing page and other pages on site that collects and transmits data before any additional requests from server and transmits the data back to the PureClick Server. This transmission occurs regardless of user action (see box 48 in FIG. 2) inclusive of the use of the back button, closing of the browser or any navigational action by the user.

Exemplary information collected for any and all pages where JavaScript is enabled includes: action on doorman inclusive of time on interstitial before user action and correlated to user action; URL/Page visited and time on that landing page, other pages, site inclusive; order of page clicks; all pages in aggregate; all time on site in aggregate.

In an exemplary third step, information is recorded & analyzed on a per click/per transaction basis and compared with doorman presentation conditions set by the vendor. In such step, the doorman is presented based on Vendor conditions (triggers). Then, the doorman is populated with vendor paid keywords and/or user searched keywords.

Exemplary recorded actions and time are listed at 48 in FIG. 2, including close of browser/new URL; back button; continue; return to URL of origin; bookmark; preview mouse on; multi-media use; and other.

This provides a user driven defense against the disparity fraud, which can be used by Search Engine Companies in presenting high PPC keywords with poorly correlated sites. Also, in exemplary embodiments, the user makes the final determinant decision as to whether they will enter the site. If the user decides to enter the site, a valid click is documented. If they choose not to other actions are documented as well.

The following provides another exemplary embodiment with a focus on an exemplary doorman interstitial, also called an “intelligent interstitial.” Accordingly, another exemplary embodiment provides a system and method for preventing click fraud and/or determining valid or invalid clicks are provided by the introduction of the intelligent interstitial (doorman). As is described with reference to this exemplary embodiment, the intelligent interstitial (doorman) is a dynamically and/or statically generated text and graphics search-user interrogation filter for search and paid advertising directed Internet traffic. The doorman is presented on a website before entry to the target URL when a user is directed from a search or PPC advertising. The doorman is dynamically and statically formatted and populated with information to allow easy interrogation of an incoming search user to a target URL to determine the legitimacy of the originating click and the related PPC charge. Also, further exemplary alternate embodiments, described later, provide a doorman that can be used directly by a search engine company in a mouse-over form to provide enhanced search assistance or by the target site for the same purposes as the interstitial delivery.

This exemplary system and method may be used to measure click related data, decide according to target URL defined conditions whether to present an Intelligent Interstitial (doorman). The system then can decide according to target URL defined conditions how to populate the interstitial and then measure search user interaction with the interstitial. The system then can use target URL defined conditions of interstitial interaction to determine click validity and in the event of a valid click continuing to the target URL, optionally measuring on-site behavior. This exemplary intelligent interstitial system uses measured data from the original click, interstitial behavior, and optionally target URL website measured behavior, which may be merged into a database providing user data for each individual click transactions. This permits generating of reports specific to seeking credits for payments on invalid clicks and other website intelligence and optimization.

In exemplary embodiments, a website interface may be provided by an intelligent interstitial provider (which may be the publisher, a third party or an advertiser) for implementation by an Advertiser of the doorman interstitial. A simple interface may be provided to select the conditions, display and behavior of the doorman interstitial. In exemplary embodiments, the intelligent interstitial provider website returns a character string to the target URL user which is used as the referring URL for ads generated with certain keywords, networks or relationships.

In exemplary embodiments described herein, the intelligent interstitial (“doorman”) is named as such because it resides on the intelligent interstitial provider servers interstitially or between the search engine company search results page and the target URL website. This means that no code need be loaded into the target URL site minimizing related technical complexity overhead and relieving the target URL administration of installation requirements. By reducing the barriers to implementation, the interstitial adoption is enhanced.

JavaScript or other program language code may be installed in the interstitial and/or the target URL to collect click content and search user behavior on the interstitial and optionally the target URL. This click data may be collected in a database. The intelligent interstitial provider can provide software to analyze and report on the click data database. The reports can be used to seek credits from search engine companies for charges on invalid clicks, creating performance based relationships based on behaviors, affiliate selection for direct advertising, target URL website and keyword optimization.

Exemplary features of this intelligent interstitial or doorman include: dynamic format and content as a function of numerous external variables; requirement of a human decision by the user; provision of a decision based presentation; tracking of all behavior and click stream data for advertising accounting and auditing. Also, in exemplary embodiments, the intelligent interstitial doorman code may reside on the intelligent interstitial provider server, thus relieving an advertising URL of unnecessary program changes and bandwidth utilization. An additional feature may also include the use of a mirror page to evaluate TOS (Time on site) and action without the implementation of server side code on target URL site.

In exemplary embodiments, dynamic configuration may be accomplished after an automated review of the data in the incoming click stream. Analysis of the incoming data stream may include the determination of a Match Quality score for disparity. Analysis may also be relative to a known referring URL singularly or in conjunction with other attributes. Further, the analysis may be relative to other click stream data known to be associated with click fraud and other invalidating behaviors.

In exemplary embodiments, presentation criteria of the doorman can be set by the target URL from choices made in an online setup phase and include one or more of: the use of information collected and assigned probabilities to determine the likelihood of a repeat user to determine whether an interstitial is delivered; the use of Time on Interstitial and resulting action to further assess the likelihood of a duplicate click transaction at a later date; the use of a random generator to determine whether an interstitial is delivered; time of day; keyword present or not; geography and referring URL.

In exemplary embodiments, the validity of the click transaction can be determined by the behavior of the Search user in response to the doorman attributes. Further, paid search terms PPC ad keywords and the correlated user search term may be displayed on an interstitial to show the user the relevancy given from paid placement. A relevant image may also be presented on an interstitial to visually represent the purchased keyword. A preview on a mouse over may also be used to display the target URL for continuation to site or other images and thumbnails. Any such presentation may be configured to require a human decision by the user to aid in determining validity of a click transaction. Further, a double bounce, constituting time on page after the doorman on the target URL as well as navigation may be used as a guide to determine integrity of continuation.

In other exemplary embodiments, a click data database can be used to provide a variety of reports beneficial to the search engine company and the advertiser. Such reports may include, without limitation: a credit report for claiming refunds from the search engine company for fraudulent clicks and invalid clicks; a report on the quality of the certain keyword in terms of their continuation rates at the doorman; a list of the most successful referring URLs to allow the Target PPC advertiser to establish direct advertising relationships and eliminate the search engine company from the process; a report on the quantity and type of bot traffic; a report on keyword quality or Match Quality Score; and a report on referring URL quality scores.

The above will be described further in additional detail with reference to additional exemplary flow charts and other FIGURES. The following describes merely exemplary forms of an intelligent interstitial (“II”), its business process, its attributes, the related database information and its reporting functionality. For the purposes of the below description the following terms will be used (it should be recognized that these terms are used for the convenience of description of the below exemplary embodiments and should not be construed in such a way as to limit the overall invention):
II/provider—The company providing behavioral and click specific on-site tracking tied to the click transaction and said behavior, the Intelligent Interstitial or doorman service, e.g., PureClick. The company may be the publisher, a third party or an advertiser and/or the Target site.
SE/corp—The search Engine Company, i.e. Google, Yahoo, etc.
S/user—The user seeking information from publisher
Target URL—The advertising or target URL and PPC advertiser
Doorman—The Intelligent Interstitial, a name that suggests its function

### An Exemplary Doorman Business Process

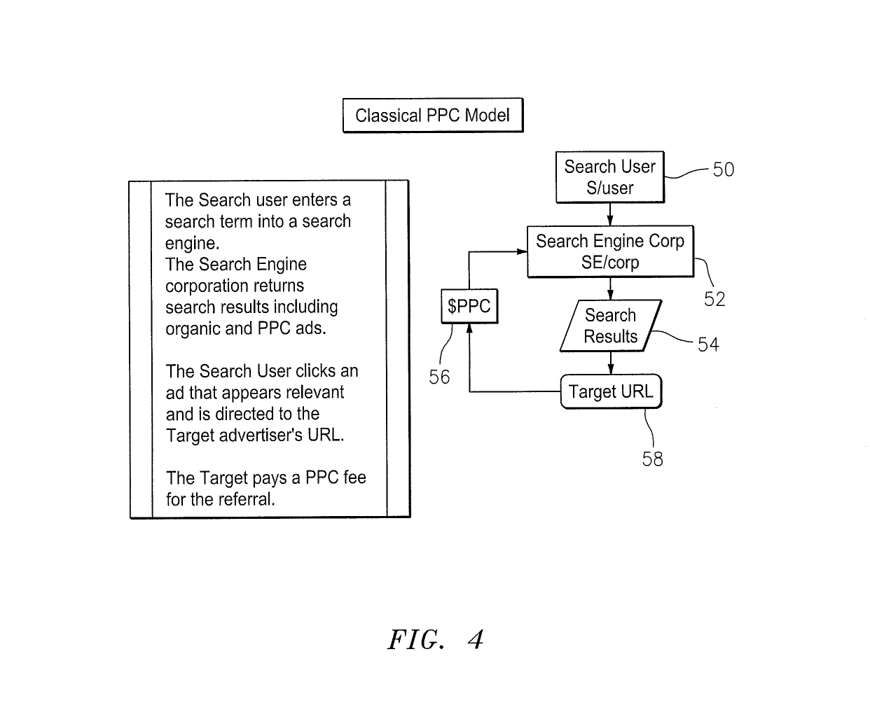

Referring now to FIG. 4, the conventional PPC business process initiates once an S/user 50 enters a search term into a search engine operated by the SE/corp 52. The SE/Corp then returns the search results 54, which generally includes the organic search results and Pay Per Click (PPC) advertisement information 56. If the S/user decides that any of the PPC ads presented are of interest, the S/user may click the ad. Once the click is made the conventional process is that the SE/corp records the click and sends the S/user to the Target 58. The Target's PPC account is deducted by an amount relating to the bid value of the keyword associated to the PPC ad. The current PPC model is shown in FIG. 4.

The problems of click fraud or invalid clicks based on behaviors, which are described in various places above, result in significant losses to Internet advertisers. However, a target URL could contract with the II/provider to perform the duties of a doorman. The doorman would systematically filter arriving S/users to determine whether they and their related click have been fraudulent or so loosely associated by SE/Corp as to render them invalid. The doorman or Intelligent Interstitial will record all the information relating to the click and the behavior of the alleged S/user by presenting certain information and inquiries and recording the S/user's respective responses. The S/user is described as “alleged” because until confirmed the Target does not know if the click is fraudulently activated by a robot or some other illegitimate user, or that the S/user inadvertently clicked a PPC ad assuming that the SE/corp had presented choices relevant to the S/users keywords. It is a premise of the present disclosure that the SE/corps are presenting high paying ads with low relevancy to the search or high associated keyword disparity in order to maximize PPC ad revenue

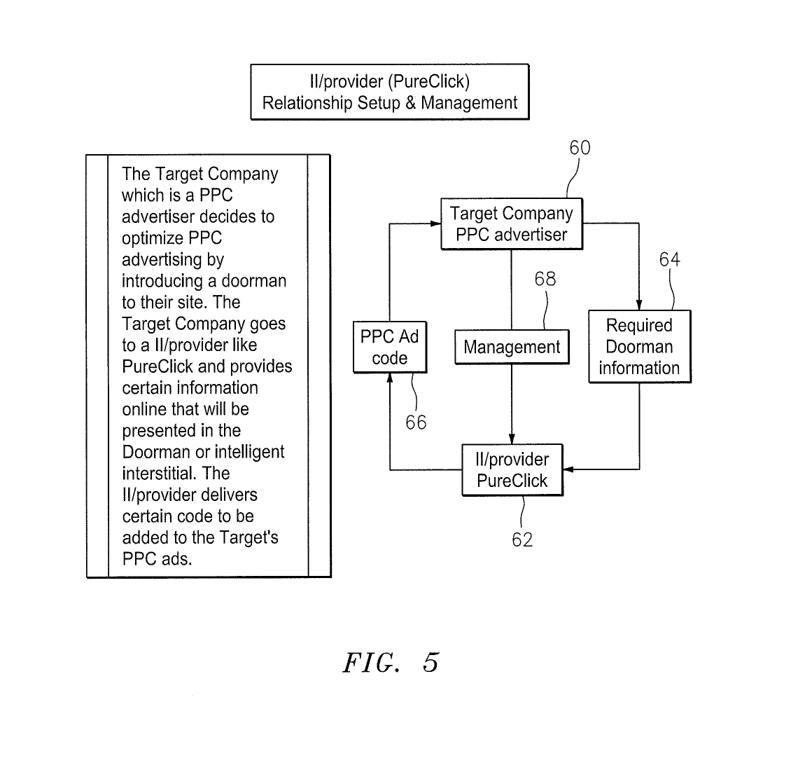

Prior to the activation of the Intelligent Interstitial (hereafter called the doorman) for particular keywords a one-time setup procedure is followed where certain online information is provided by the target URL in response to queries by the II/provider, in order to correctly structure and present the doorman. The II/provider generates certain URL data to be included in the PPC ad link by the Target. This URL data will redirect all PPC directed S/users to the II/provider servers where they may be interrogated by the doorman before entering the target URL or returning to the search results. See FIG. 5 for an exemplary setup of the Target and II/provider relationship.

In such exemplary setup, a Target company, which is a PPC advertiser 60, decides to optimize PPC advertising by introducing a doorman to their site. The Target company contacts a II/provider 62, such as PureClick, and provides information 64, e.g. online, that will be presented in the doorman, or intelligent interstitial. The II/provider delivers certain code 66 to be added to the Target's PPC ads. The item management 68 represents the flow of ongoing contact between the Target Company 60 and the II/provider 62.

Hence, exemplary aspects of the current invention propose that, instead of the S/user being sent directly to the target URL, that they rather be directed through the servers of the II/provider. The S/user is redirected by clicking the PPC ad. The PureClick Server Tracking URL includes keyword purchased information and referring URL information and a redirect URL to land on targeted page with JavaScript enabled. The information collected is then used to activate and populate an interstitial known as the doorman as a final determinant of click validity. The doorman presents information on disparity and provides a simple set of choices that will discover most prevalent forms of click fraud. That is, the II/provider captures all the information relative to the newly arrived S/user and the information which comprised the search and then may present an interstitial or doorman. The interstitial is so named because it interposes itself between the Search Engine redirect from the PPC ad and the target URL. Exemplary embodiments of the interstitial are described as Intelligent since a number of decision processes are executed which determine the format and content of the doorman's appearance and interrogation.

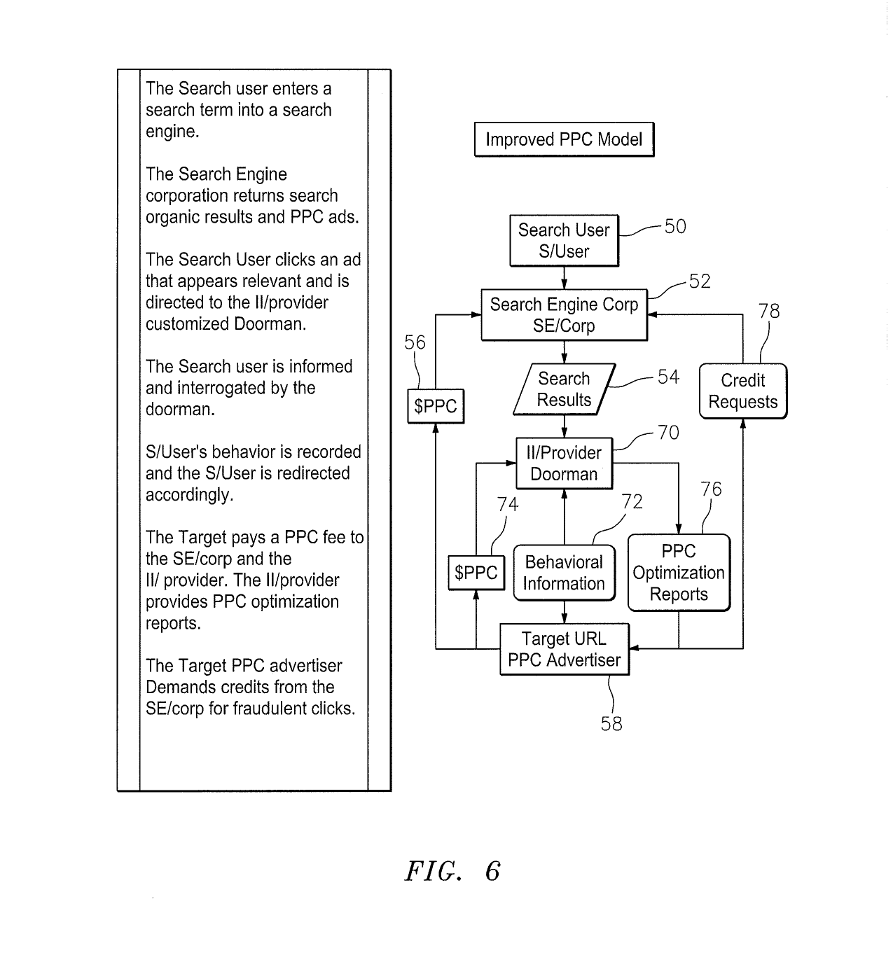

The information recorded by the II/provider may be formatted into numerous reports which provide the Target sufficient information to optimize keyword selection, seek credits from the SE/corp for fraudulent and invalid clicks and identify possible direct affiliate relationships. In general, this may be implemented to increase the effectiveness of PPC ads and minimize costs. The II/provider may also be compensated for the services of their doorman by a PPC model. See FIG. 4 for an exemplary classic PPC business process and see FIG. 6 for an illustration of an exemplary improved PPC Business Process.

In the exemplary improved business model of FIG. 6, a search user (S/user) 50 enters a search term into a search engine. The search engine corporation 52 returns search organic results 54 and PPC ads. The search user 50 clicks on an paid ad that appears relevant and is directed to the II/provider customized doorman 70. The search user's behavior is recorded 72 and the search user is redirected accordingly. The Target 58 pays a PPC fee 56 to the search engine corporation, as well as a fee 74 to the II/provider. The II/provider provides PPC optimization reports 76. The Target PPC advertiser demands credits 78 from the search engine corporation for fraudulent and invalid clicks.

### Intelligent Interstitial (Doorman) Features

The interstitial doorman is designed with numerous features that are activated and presented according to a fixed or automated analysis system, which analyses the nature of the income click from a PPC ad. By collecting the following information a decision is made as to the content and format of the doorman. The doorman configuration flow is illustrated in FIG. 2.

Among others, the following data may be collected intermediately on the PureClick Server as the user passes from one site to another and recorded in a database; establishment of a transaction ID; time date stamp of click; IP address; user agent; cookie; referring URL; primary referring URL; origin URL; and keywords, among others.

### Doorman Elements

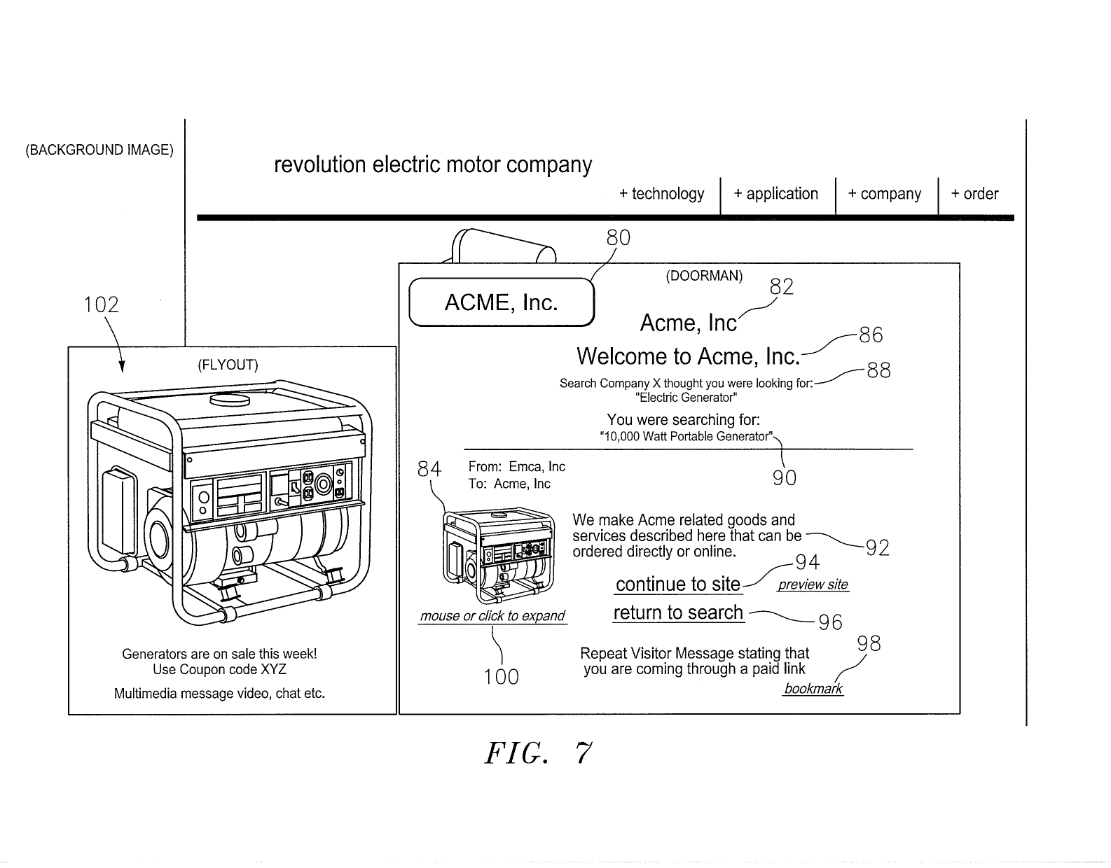

In exemplary embodiments, the doorman may be constructed of several elements which can be activated and modified according to certain click data or target URL vendor requirements. These elements can be activated and modified according to certain click data or target URL vendor requirements. Exemplary door man elements are shown in FIG. 7 and include one or more of: the company Logo 80, loaded in the setup stage; the company Name 82, loaded in the setup stage; a product relevant picture 84, loaded in the setup stage; a welcome message 86, loaded in the setup stage; originating Keyword search term 88, determined from the incoming click data stream; purchased Keyword term 90, determined from the set up stage; description of the site 92, loaded in the setup stage; a button for continuation to the site 94; a button for return to the original search results 96; a button for the repeat visitor bookmark creation 98; and a rollover button 100 to provide a view of the a product relevant image 102 all presented over a greyed-out image of the selected target URL landing page which is also loaded in the setup stage and additional features such as multimedia and extended images in the form of a flyout or other methods.

The doorman 24 may be presented (as in FIG. 8) on a lightly greyed out image of the target URL landing page, or any other page the page established during set up, 104 to give the appearance that the S/user has arrived at the site and that the doorman is part of the site and not on the II/provider server.

The behavior of the S/user may also be recorded by the collection of data from JavaScript or other code on the doorman, landing page and other pages on site that collects and transmits data before additional requests from the server and transmits the data back to the II/provider server. This transmission occurs regardless of user action inclusive of the use of the back button, closing of the browser or any navigational action by the user, including the use of the company/client in the top level domain/URL. The information may be recorded & analyzed on a per click basis and compared with doorman presentation conditions set by the vendor.

The doorman may be presented based on Vendor conditions. Then the doorman may be populated with vendor site summary keywords and Search user keywords, which provides a user driven defense against the disparity fraud that is used by SE/corp in presenting high PPC poorly correlated sites. Also, the user may make the final determinant decision as to whether they will enter the site, at which time a valid click is documented.

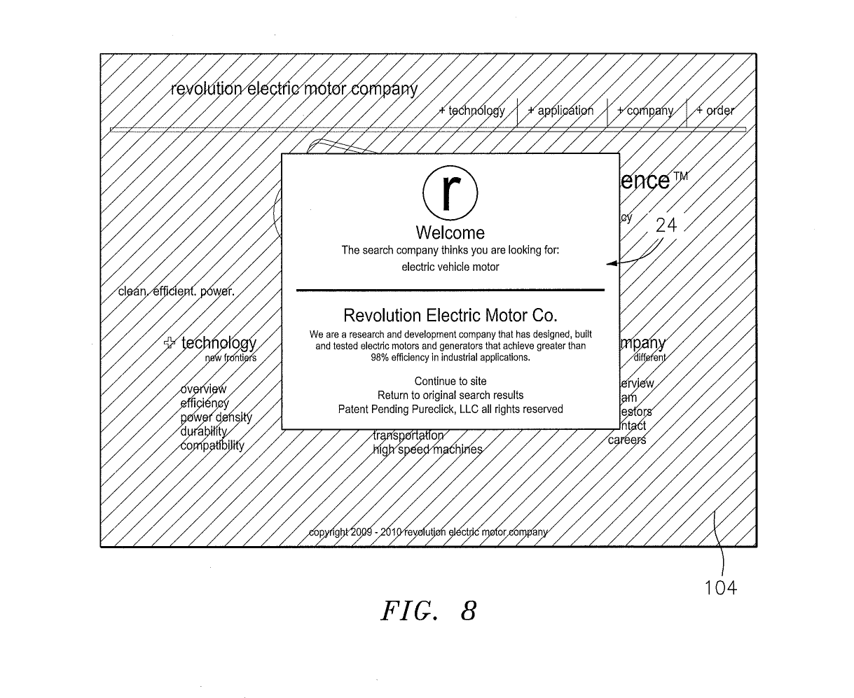

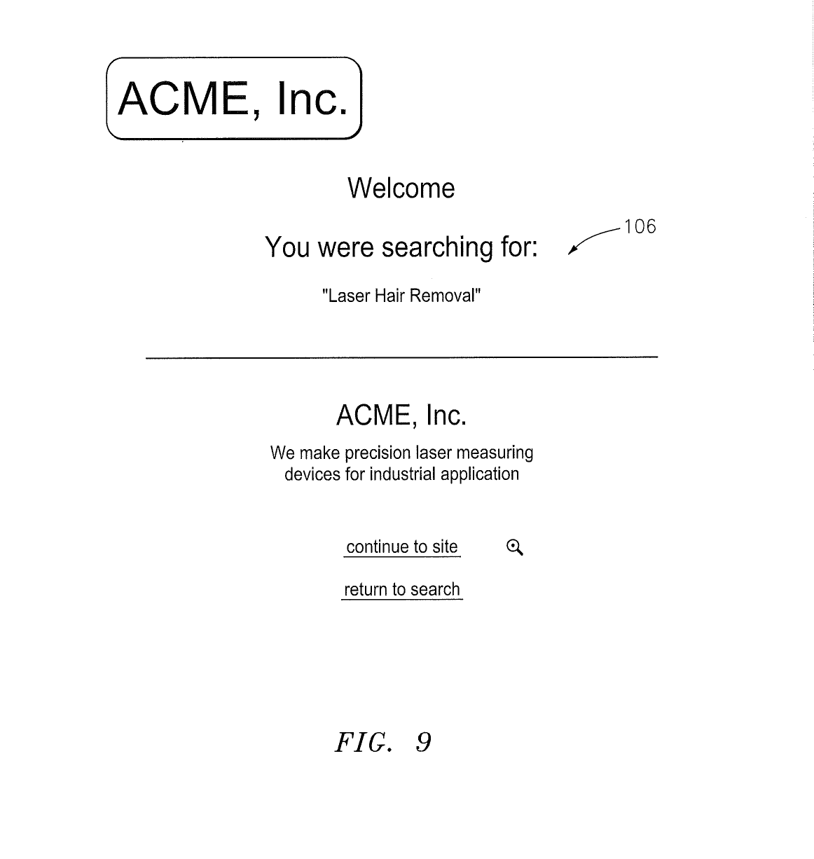

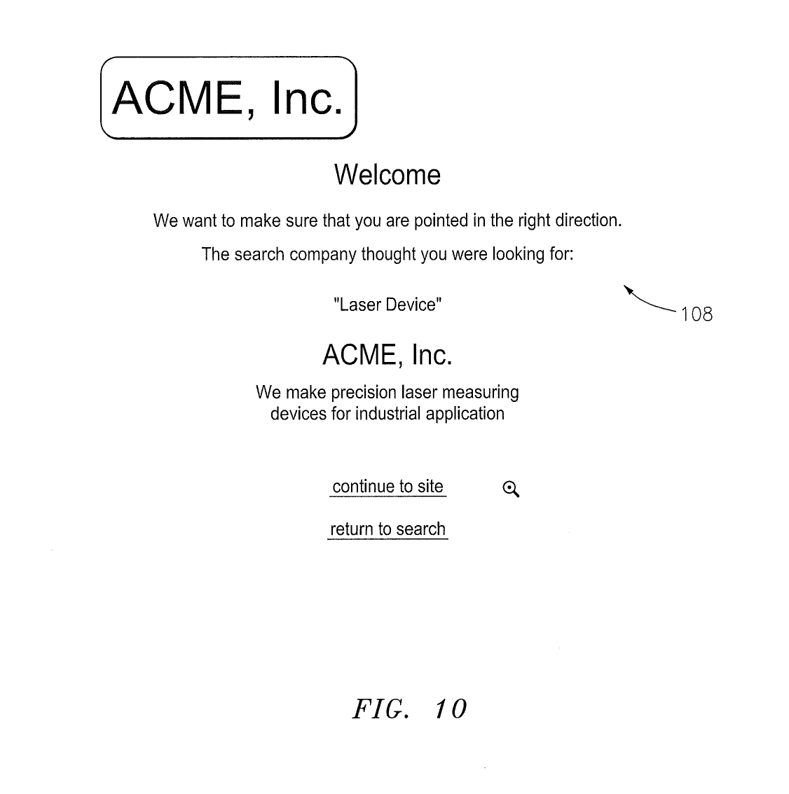

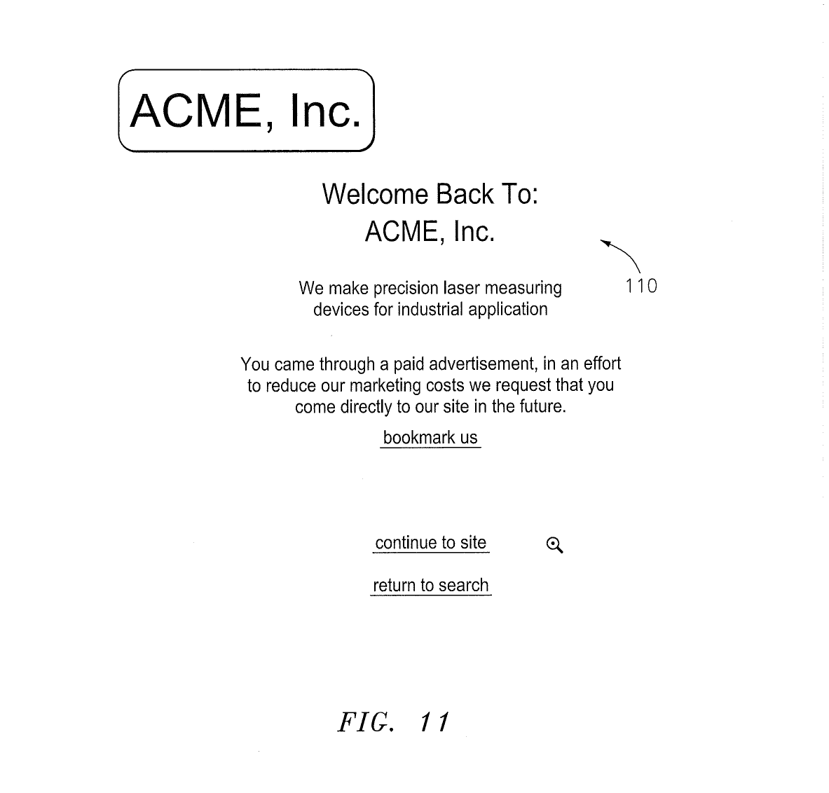

Numerous versions of the doorman may also be presented, depending on various conditions. Examples of different conditions and possible doorman designs are: known keywords 106; unknown keywords 108; repeat User 110; and affiliate User/aka direct and Display Network 112. Examples of such possible doorman configurations are shown in FIGS. 9-12.

### Data Collection and Storage

Analysis of the click stream data and user behavior may also be made using an embedded program code in order for data to be collected and amalgamated for reporting. An example of such an embedded program may take the form of JavaScript that resides on the Interstitial and/or the Advertiser site, as in FIG. 1.

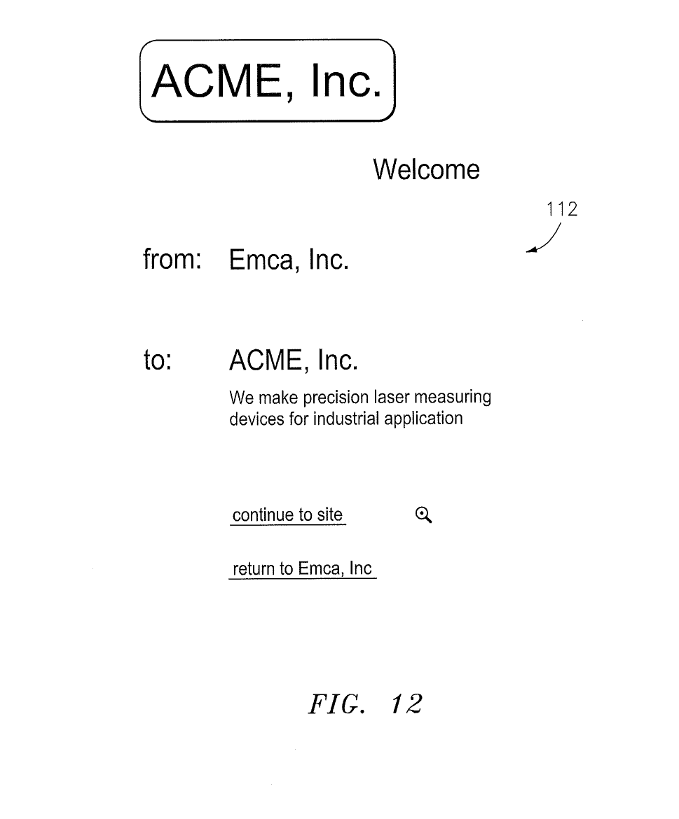

Thus, the Interstitial may collect the click stream data as shown in FIG. 13. The S/user behavior data may also be collected on the interstitial and can include (among others) one or more of: the use of the back button for navigation; the closing of the browser; the continuation of the User to target URL; the typing of a new target URL in browser; the return the originating URL; other associated actions to the click transaction; and the time to action for any of the preceding and others.

Exemplary FIG. 13 shows an exemplary PureClick advertising link 114 with the ability for a mouse-over 100 giving rise to summary data of a target URL and/or Target site 102. The FIGURE also illustrates servers 14 performing data collection 18, e.g., at 116: ID (Transaction ID); IP_address; IP_details; User_agent; Rand_id; Campaign_id; User_id; Reuser; referring URL; User_rand_id; Time_on_site; JS_enabled; Cookie_enabled; Search_Keywords (parsed); Created_date; and Linked Keywords (link creation), among others.

Exemplary behavior analysis at 118 includes: On/off; Keyword Disparity Value; Re-user Probability Value; Display Percentage Value; Referring URL Continuation Percentage; Referring IP Continuation Percentage; User Continuation Percentage; and Transaction Continuation Percentage, among others. A decision 120 is made whether to proceed with doorman code at 122 (e.g., using JavaScript to collect records at 124, such as: Transaction id; doorman id; Served Yes/No; Action Taken; Time to/on Action; and target URL in/out time (back button), among others). Further, at the Target site 58, if appropriate code (e.g., JavaScript, among others) is implemented on-site, as at 126, exemplary site records may be recorded (as at 128), such as: Transaction id; Site Record id; Pages; Time on Pages; Time on Site; and Page views, back button navigation among others.

The collection flow and server organization for this exemplary data collection and storage is shown in FIG. 1. As disclosed variously above, detailed onsite behavior can also be captured for any and all pages where JavaScript (or other appropriate program) is enabled. Exemplary types of collected information include, but are not limited to: action on doorman inclusive of time on Interstitial before user action and correlated action; URL/Page visited and time on that particular page, site inclusive; order of page clicks; use of back button for navigation; all pages in aggregate; and all time on site in aggregate.

A variety of reports analyzing the click database can be used by the Target PPC advertiser. These reports may include, among others: a credit report for claiming refunds from the SE/corp for fraudulent clicks; the quality of the certain keyword in terms of their continuation rates at the doorman; a list of the most successful referring URLs to allow the Target PPC advertiser to establish direct advertising relationships and eliminate the SE/corp from the process; the quantity and type of bot traffic; Keyword quality; and most prevalent forms of abandonment for Keywords.

### FURTHER EXEMPLARY EMBODIMENTS

The following features provide additional exemplary embodiments for various aspects of the presently described invention.

### Mouse-Over Interstitial

An exemplary mouse-over embodiment of the interstitial doorman may also be provided for use by an SE/Corp, rather than as a service by an independent II/provider. Such may be provided as a search engine attribute and a convenience to the search user as well as a defense against invalid clicks for the PPC advertiser (target URL).

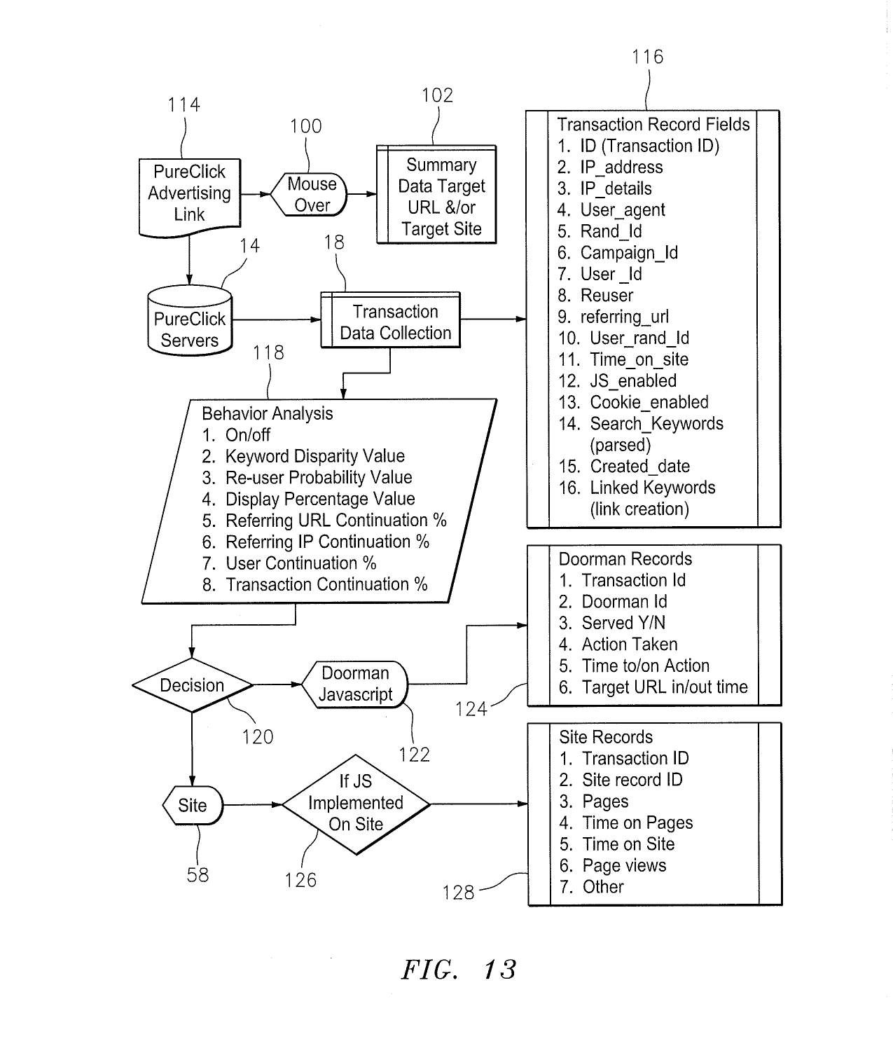

FIG. 14 illustrates an exemplary mouse-over flow diagram. In such diagram, a server advertising link publisher 130 provides mouse-over link capability 100 that provides a preview or summary 102 of a target or related page. The SE/Corp may also choose to serve Interstitial locally before or after logging the click transaction on their Site prior to the target URL A record may also be made of the mouse-over selection at 132. A content delivery decision 134 may be made to present static summary data 136 in the interstitial content or dynamic summary data 138 in the interstitial content. Regardless, information such as time and action 23 can be recorded relative to the Target site 36.

The mouse-over on the actual search results page may initiate the display of the interstitial for the purposes of pre-qualifying the click transaction. As the mouse is moved over the PPC ad on the search results page, the interstitial is displayed.

This is in contrast to the presentation of a preview screen of an actual site, which has been offered by SE/corps. The small preview screens, however, are too small to read and do not effectively summarize data for or interrogate the S/user.

In exemplary embodiments, the mouse over interstitial doorman summarizes the related PPC ad target URL in terms of simplified comparison of search and target URL keywords. In this manner, the search user is provided easy to understand guidance to quickly and effectively decide whether they should click through to the site. In effect, the search engine organization provides the presently described service as part of its search results, thus aiding the search user and protecting the PPC advertiser/target URL from invalid clicks or fraudulent behaviors.

The preview may be static content that is exemplary of the target URL and represents what is delivered on the doorman page. The preview may also be dynamic based on click data, previously recorded behaviors on the advertiser site or across the network of sites.

The delivery of the mouse over an advertisement may be recorded as an impression, mouse over may be recorded as a delivery, and click may be recorded and tied to presently described system records of the Interstitial and or website. In exemplary embodiments, whenever possible this may be tied to a downstream record based on click through of the mouse over, for example through a session ID when that is available.

### Target URL Hosted Doorman

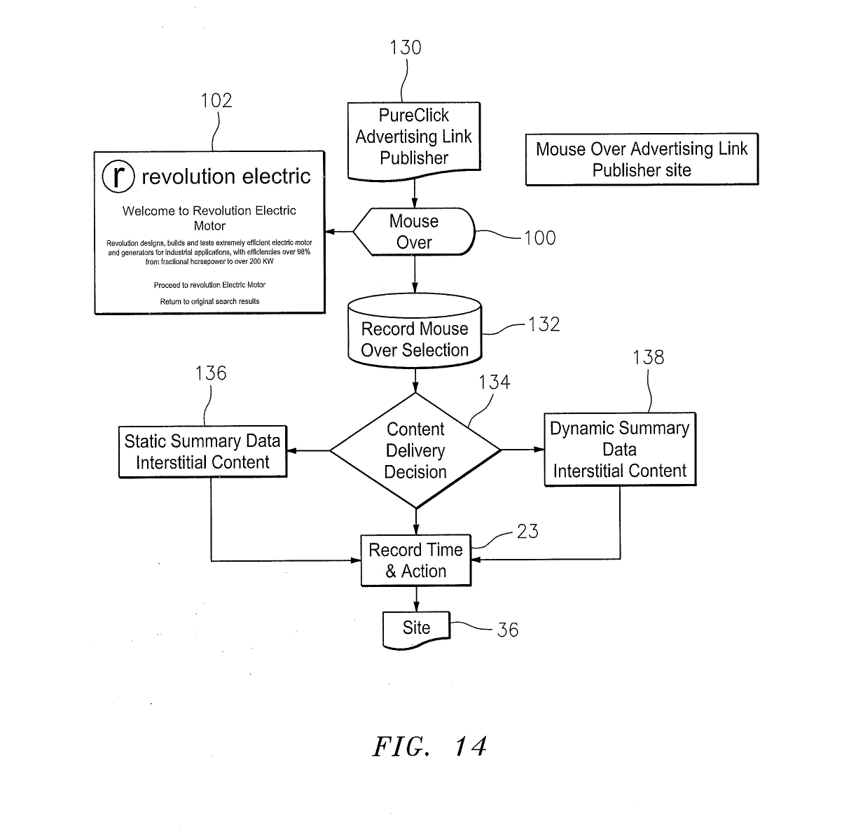

As we have noted herein, code for the interstitial may be presented via any convenient participant, e.g., by a third party, by a search engine company, by a Target site, etc. In the exemplary embodiment illustrated at FIG. 15, a target URL provides server-side doorman capability at 140, giving rise to an exemplary doorman 102.

### Quality Score of the Referring URL, a Search Engine Feature

The nature of exemplary data collected in the click fraud and click validity process allows other uses beyond the determination of valid clicks. A database can be built of target URLs (referring URLs), which attempts to create a quality score for each target URL. Certain target URLs will have better or worse S/user behavior associated with it based on the historical records of past transactions and notably paid and searched keywords. The Quality scoring can be used by SE/corps and affiliates to sort search engine results pages according to target URL quality scores, and to present the most useful and successful target URLs to S/users for a particular search keyword combination.

Algorithms may be provided that create a quality score for the referring URL, for example based on one or more of the following, among others: traffic behavior; interstitial behavior; website behavior; intended keyword; and Mouse Over behavior.

### Match Quality Score (MQS) AKA Disparity

As is described above, the match quality score (MQS), or disparity, relates to paid search terms (PPC ad Keywords) versus a user-searched term. Further, the above notes that such a disparity may be used to quantify user behavior and/or to govern the display of a doorman when a threshold is met by the user. In exemplary embodiments, such disparity may take in to account one or more of:

1. The number of keywords that match between paid and searched terms;

2. The number of search keywords that match against the total number of searched keywords;

3. The order of the keyword terms against the paid keywords; and

4. The number of partially matching keywords against the partially matching search keywords.

5. The use of keyword(s) from one or more disparate campaign(s) or lists of selected keyword(s) for the purpose of calculation of the Match Quality Score.

Exemplary algorithms for determining disparity follow:

Special Values:

if nm=0, QS=0

if search keywords exactly match paid keywords, QS=100

Quality Score Definition (General Case):

QS=pk_ratio−sk_ratio−order_penalty−partial_penalty

pk_ratio(nm, npk):

nm/npk*100*(1+(1−(nm+1)/(npk+1)))

sk_ratio(nm, nsk):

(1−((nm+10)/(nsk+10)))*100

order_penalty(noo, npk):

(noo/npk)*12

partial_penalty(npsk, npk):

(npsk/npk)*8

### DEFINITIONS

QS=quality score
nm=number of words in search keywords that match (partial or exact) a paid keyword
npk=number of paid keywords optionally inclusive of other advertiser paid & unpaid keywords
nsk=number of search keywords
noo=number of out of order keywords. Order is defined only relative to other paid keywords
npsk=number of partially matching search keywords
apuk=number of disparate keyword(s) from other associated paid and unpaid lists

Because the above essentially begins with a ratio, the above algorithm effectively “expects” that the fewer paid keywords there are, the more important it is to match all or most of them in order for a search to be good. That is, e.g., matching 1/2 of paid keywords is not seen as being as good as matching 3/4.

The second term of the pk_ratio moderates that effect, so that 1/2 is (by default) worth about 67 points rather than being worth 50. In essence, this means that the highest possible score for a search that matches (at least partially) 1/2 of the keywords is 67. However, matching 1/2 of the paid keywords with a 4 word search string is worth less than 67; and it is also worth less than 67 if the one match is partial.

The terms of the QS are arranged such that the weights are in an order that corresponds to the ordering of the list of qualitative criteria given, i.e., how many paid keywords are matched has the highest weight, and the penalty for partial matches on words has the least weight. Variations on this include the additional use of Associated paid and unpaid keyword(s) in the associated calculation between the paid pk and sk for modification of the sk as an independent adjustment prior to or post calculation.

### Optimizing Affiliate Relationships, an Advertiser Advantage

PPC ads for certain affiliates of the SE/corp are presented in typical search results. These affiliates usually focus on an area of specialization, but can also be what is known as display networks. The economics of this affiliate relationship result in a sharing of the PPC revenue between the SE/corp and the affiliate in the event that a target URL ad is clicked. The target URL company therefore pays advertising costs to both parties, the SE/corp and the affiliate. Certain affiliates are more successful at providing valid clicks than others and quality varies significantly. The target URL company can examine data collected using the technology of this invention and determine the most effective referring affiliates.

The target URL company can then proceed to establish dedicated lower cost relationship directly with the affiliate, thereby eliminating the SE/corp as an intermediary. The II/provider may thus provide reports from the click data that assists in this process.

### Repopulating an Original Search Term, an Additional II/Provider Revenue Source

In exemplary embodiments, if the S/user selects to return to the search results page, either by clicking the “back button” or selecting the “return to search results page” option, the original search terms from the paid transaction as defined by the Advertiser (as is different from the associated terms from the SE/Corp) would be submitted in a form as an affiliate or as the target URL to the search company for re-monetization. This would be done independent of the Advertiser, but for their benefit in order to mitigate the costs resulting from the “invalid” or “fraudulent” clicks.

Use of the Action on the Interstitial and/or Time on Interstitial and click record could be used to create a new initiated search from the II/provider. A record could be kept on behalf of the Advertiser and disbursement made from revenue garnered from those transactions. Effectively remonetizing the click transaction for opted out S/User.

### Filters to Ensure the Quality of the Traffic

In exemplary embodiments, the doorman may also act as a filter, both to set expectations and to increase the tendency towards a quality experience on a target URL. In many cases the search user has an extremely limited view into, and understanding of, the target of the advertising link that they click on. Web sites vary incredibly in user interfaces, navigational schemas, graphics, colors and even the intent of the site to the user. Additionally, it is common practice to have the target URL only be a series of links for re-monetization of the user experience with no real content provided. This leads to a confusing experience with a high propensity for the users to abandon the endeavor altogether at tremendous cost to the advertiser.

In exemplary embodiments, the doorman provides a guided experience and the opportunity for the user to experience a soft landing on the targeted site by giving them the choices described above, as well as the ability for the advertiser to give a general summary of the site and possible potential areas of interest to the user. In essence, this gives the user a preview of the intended experience as well as giving the advertiser the opportunity to set expectations, rather than leaving it to the user to determine these on their own accord upon hitting the landing page on the site and having to figure out all of the aforementioned issues.

In exemplary embodiments, as it relates to this, the system provides the ability to describe specific targets within a site from the doorman by one or more of: the use of a description to describe the intended user experience; the use of a description to denote something unique to the site including sales, coupons or other incentives; the use of information gathered from previous doorman experiences to serve up a smart user experience, including dynamic formatting of the user experience based upon other actions from the user on doorman served on other sites (other sites including preferred navigational methods); the use of a description based on the originating site and/or a target URL to set expectations on the next user choice; the use of a description based on the target site and offering, with links; providing linked lists within the description; and providing lists within the description.

### Behaviorally Optimized “Learning” Search

Certain exemplary processes of search described herein may be described as static in the sense that certain search formulas are used in an effort to provide the pertinent search results and ads. In embodiments wherein no user inputs exist, the process may lack the ability to sample the search users' satisfaction with the information presented.

In exemplary embodiments, the doorman's ability to extract information on user satisfaction can provide essential information when optimizing the search results, providing subsequently higher relevancy and higher cost per click for certain search term combinations.

In such exemplary embodiments, the paid keywords from the input on the doorman are known when the campaign is created. Further, the system may know whether the referring URL and content was relevant or not to the keywords. Accordingly, the system can profile visitors' behavior and acceptance of relevant content on the origin and target. In such exemplary circumstances, a search no longer need be based on content, but may instead be based on aggregated click behavior.

The doorman may thus provide information for an optimized and search engine algorithm, namely a behavioral one. This may be generated by an interview of a user and/or whether a keyword and the target URL correspond to desirable content. Further, this may be based on the point of origin as well as the click patterns. Including the use of the back button with time in/out of target URL. Exemplary embodiments provide a search that learns as it is used more and more. Such embodiments may take into account both good and bad behaviors, and may be fundamentally based on the values tracked on the doorman and time to action.

Welcoming and Defending ServicesIn exemplary embodiments, the doorman can also perform welcoming and defending services. The doorman background and content can further be customized as a function of the nature of the search terms used and a specified PPC advertisement.

In such exemplary embodiments, the doorman may be served up in front of a preview of a target URL by utilizing cURL, or other methods, or caching a screen shot of the target URL or Website on the servers. An exemplary cURL requests a page, while the latter option captures a screen shot and serves it from the local servers. This image may be served up on the PureClick Server(s) and rendered to give a visitor a preview of the site that they will land on when they click on the “continue to site” button on the doorman.

In such a way, exemplary embodiments provide the ability to format any preview page desired by entering a separate value than the target URL when the content of the doorman is set up. This allows for a highly relevant background image that may differ from, e.g., a generic screen shot of the homepage. Thus, exemplary systems allow for serving a background preview screen under a doorman of any URL desired, as opposed to simply rendering a target URL. This may be accomplished when entering a URL to be rendered under the doorman by any URL as opposed to utilizing the target URL, which may include tracking URLs that impede the rendering of the background image. This URL can either be served from any location as exists today, or it may be cached on the PureClick Server(s) to speed up the delivery and allow for a preview screen on the doorman specific to an intent of the doorman (e.g., product, service, overview, taxonomy).

In further exemplary embodiments, content can also be custom generated so as to provide background content that is unrelated to a doorman Target to dissuade predatory clicks or fraudulent behavior. One such example might be rendering a background image of law enforcement, or even data that is specific to the user such as their IP address, referring URL, etc. of data that is collected through the service, to mitigate repetitive malicious attacks.

Exemplary rules for determining content on a dynamically generated preview screen may be built in to the logic of the delivery of content on the Preview screen including, e.g., number of clicks by the user, location(s), frequency of transactions, frequency across all actions of PureClick clients, etc. The content of the background image can also be dynamically generated based on a specific keyword(s) combination and optimized to a higher performing searched site with a high continuation rate.

Populating Doorman with Search Results from an Advertiser Site

Other exemplary embodiments relate to use of search user keywords to populate targeted links on a doorman from results of searching the advertisers search engine with those terms, e.g. where the referring URL is used to parse the keywords; where the keywords are sent to the advertiser's site and a set of values are returned; where the returned values are displayed as links to the selected content; where the links returned are one or more values; where a continue button to a predetermined URL is present; and/or where the functionality originates from the search company, a third party or the advertiser for the benefit of the user. FIG. 16 illustrates such a doorman with a promotional greeting 150, including a listing of top matches 152.

### Using Doorman Inquiry to Change Target URL for the Landing Page

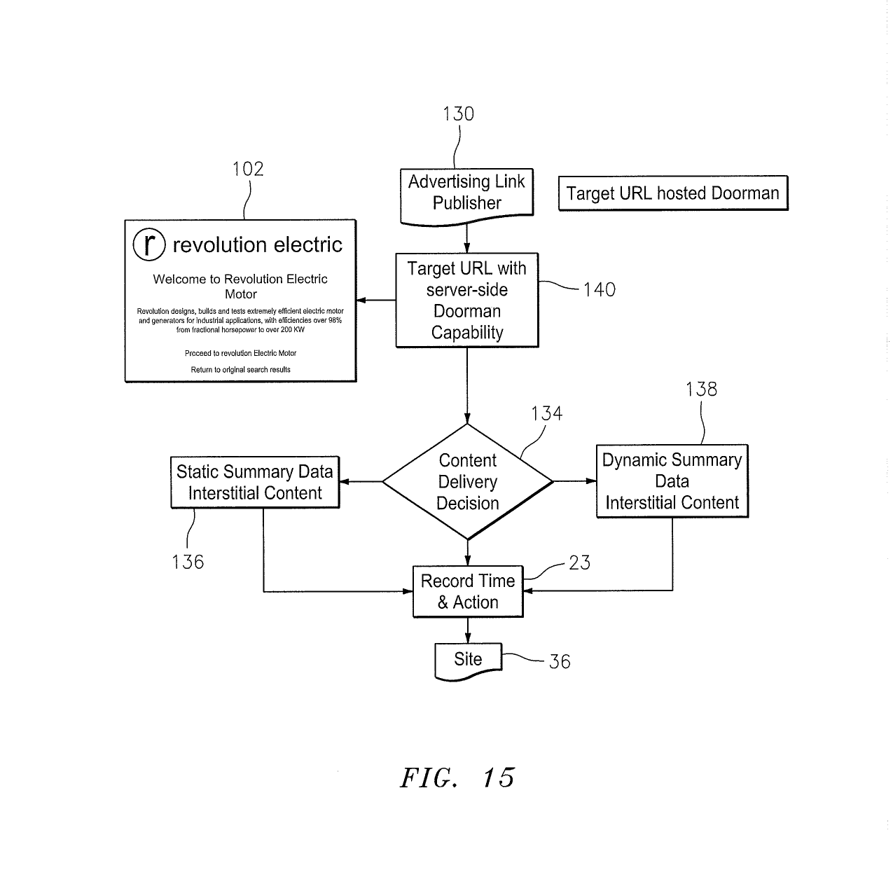

Another exemplary embodiment provides for the use of an inquiry on the doorman to change the target URL for the landing page, based on the user selection. In such embodiment, the use of one or more user selected fields may determine the most targeted landing page on a website: where the target URL is determined by the selection based on predetermined URL's; where the predetermined URL's are determined from combinations of user selections and appropriate landing pages on the Web site; where a default URL's is put in place when no selection is made; and/or where the user choice may be singular or multiple selections. FIG. 17 illustrates a doorman with site search input fields 154.

Click Bot Doorman Decoys with Tracking

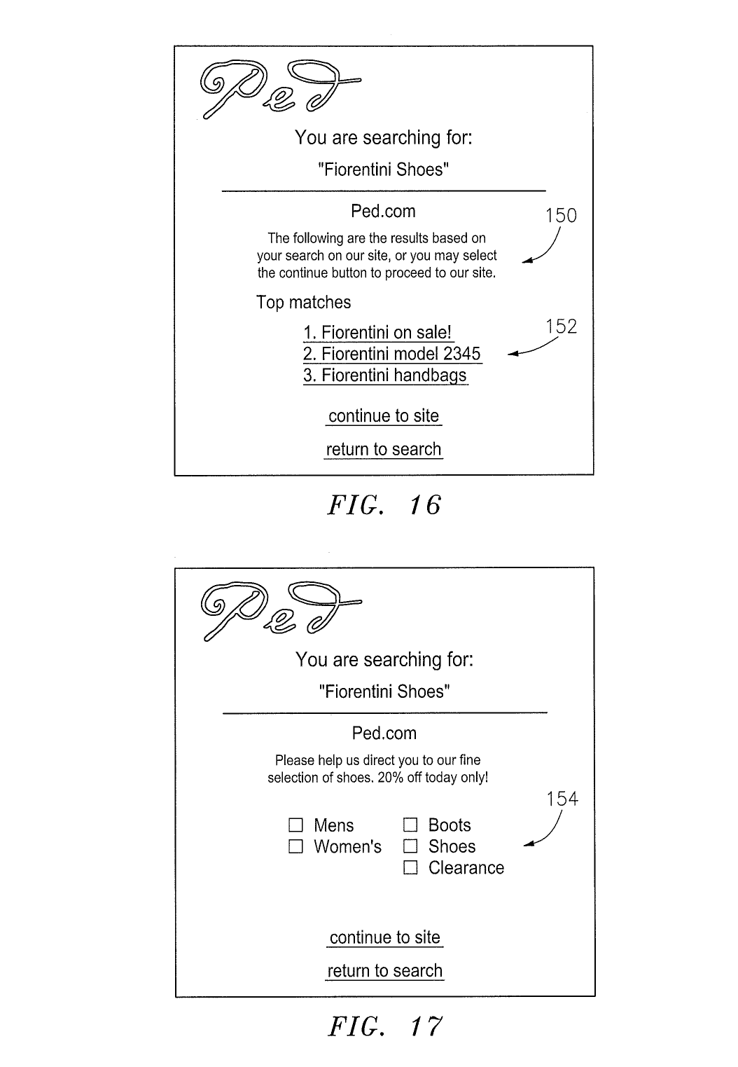

Programmatic clicking by so-called click bots relies on sophisticated examination of code by a program to find clickable functions and activate clicks. In exemplary embodiments, the doorman provides an array of clickable program elements, which are non-differentiable from legitimate selections on the doorman. Programmatic clicks of otherwise invisible buttons by click bots are caught using decoys. The programmatic click is captured as an identifiable behavior and acted on accordingly by the doorman. Thus, exemplary embodiments, provide for the use of a single or multiple links on the doorman for the purposes of tracking and diverting invalid programmatic clicking on advertisements: where the link or links target closely resembles the intended user link; where the links are hidden or camouflaged from the human eye and have no discernable function, including: where said links are text links; where said links are hyperlinked images, and/or where said links are a combination of text and hyperlinked images; where the invalid and valid links are not discernable from each other, but are different; where a record of the invalid link is logged and shows invalid activity from programmatic clicking and available information is collected for the purposes of creating: a click record of fraudulent activity including IP address and other collectable information and/or an algorithm to track future fraudulent signatures and behaviors; where the number and placement order of the invalid links is randomized in relation to each other and the valid links; where the use of invalid activity is used to negate the click transaction; and/or where the valid link is used as a tool to validate the transaction. FIG. 18 illustrates an exemplary doorman with invisible clickBot Decoys

### Additional Mechanisms for Repopulating a Search for Monetization

Exemplary embodiments further include repopulating an original search term for monetization after traffic has been paid for once the doorman has been displayed and invalidated by the search user. Exemplary methods of repopulation of the term may include one or more of: the use of the user searched term; the use of the advertisers paid search term; and a combination of one and two along with any other homonyms, synonyms or other variants for the purposes of creating a relevant keyword(s) to the originating user query, Inclusive of other keywords that the advertiser may have used on similar campaigns, groupings and other methods.

In exemplary embodiments, target of the above terms may include one or more of: the site of the originating user search; another competing search engine company; a website that uses information to create an arbitrage environment for the monetization of the term; and any website that is willing to pay or trade for traffic.

In other exemplary embodiments, remuneration of a click may include: the payment for the traffic based on the bid price for the term; a credit for the search term against any existing or future payments for traffic; and/or payment for the acquisition of the user, including changing search preferences in browser; bookmarking the target; and/or the repeat user experience and monetization of the terms, including session based activity, and future activity for a defined period of time.

In other exemplary embodiments, delivery of a link on the doorman may include; the delivery of an alternate link contingent on one or more of: an MQS score; the type of keyword; the price of the keyword; the originating parsed URL and or IP address; the referring URL; and other known attributes.

Other exemplary embodiments provide for the display of the keyword(s) for the benefit the user experience, including for example: showing the relevancy of searched versus paid terms; showing a score of the relative terms; showing the cost to the advertiser of the terms; and creating a record of the specific users activity to the Search that is known by the user and can demonstrate the intent of the user to the search engine company or other sources. This can be known from a singular click or across a network.

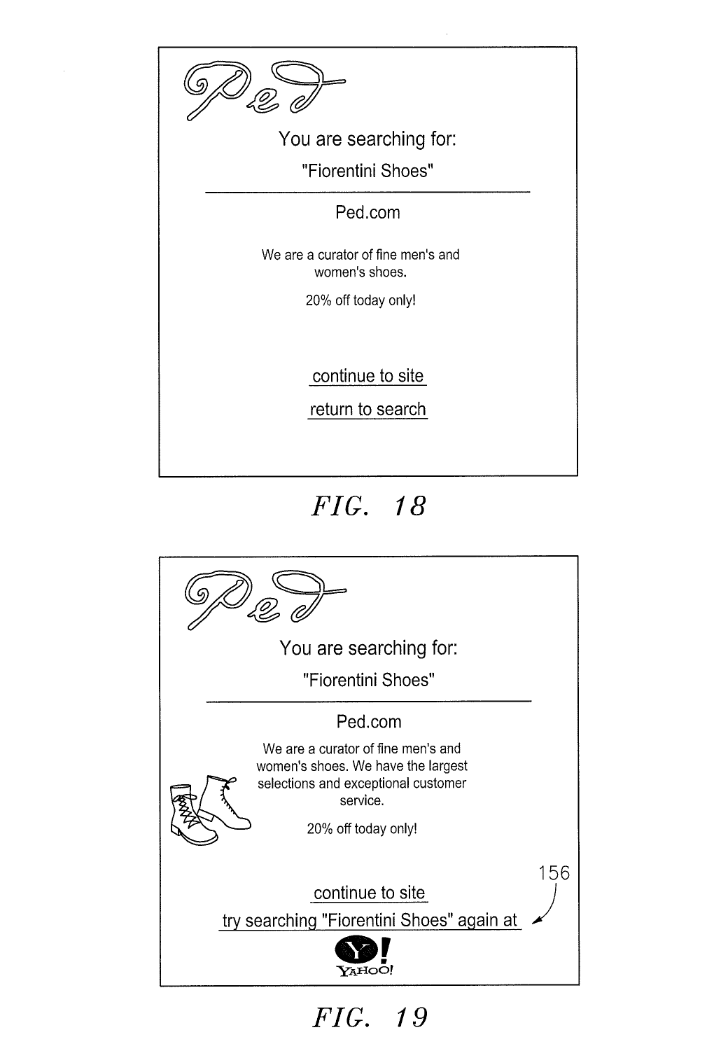

FIG. 19 illustrates an exemplary doorman with a Search Engine Migration Button 156.

### Advertiser Click Transaction Rejection Based on Disparity (MQS)

Another exemplary embodiment provides for the use of the present invention to create a transaction record where the advertiser may reject a click transaction based on the disparity between a paid search term and the user searched term, e.g., where: the user search term is parsed from the referring URL and displayed in conjunction with the paid search term; the advertiser is presented with the disparity as well as the Match Quality score; and/or the advertiser is presented with the user choice when the user is served the doorman.

### Improved PPC Ad Placement Using Doorman Data

Another exemplary embodiment provides for Improving the placement of PPC ads using aggregated data for specific search terms and doorman data for specific paid keywords, which guides the placement of ads in order to enhance continuation rates. In exemplary embodiments, the resulting searched term for every rejection results in a negative value for searched terms where the terms that are rejected are compiled and create a negative list of terms that do not include the paid terms. In other exemplary embodiments, the resulting searched term for every acceptance results in a positive value for searched terms where the terms that are accepted are compiled and create a positive list of term that do not include the paid terms. In further exemplary embodiments, the lists generated are used in an algorithmic formula for the purposes of generating a keyword profile for the advertiser to optimize future keyword associations with the paid keywords and advertisements in a PPC relationship.

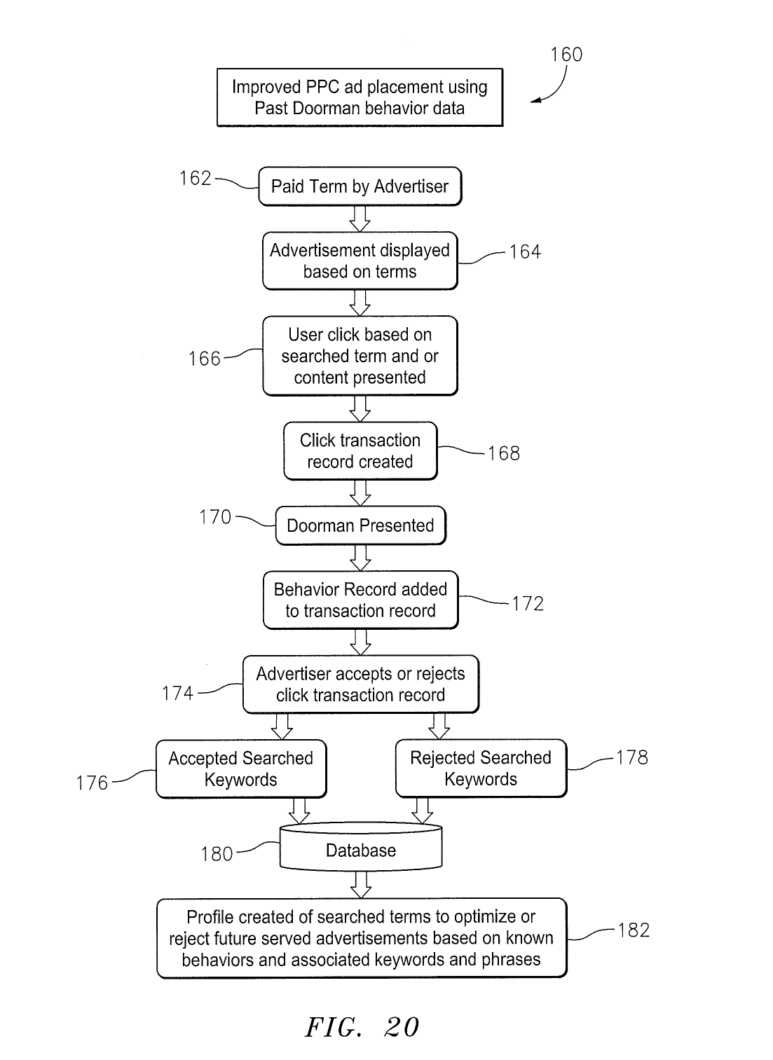

FIG. 20 illustrates an Improved PPC ad placement using doorman data, shown generally at 160, including: identifying a paid term by an advertiser 162; displaying an advertisement based on terms 164; monitoring a user click base on searched term(s) and/or content presented 166; creating a click transaction record 168; presenting a doorman 170; adding recorded behavior to said transaction record 172; monitoring acceptance or rejection of said click transaction record by an advertiser 174; accepting 176 or rejecting 178 said searched keyword(s); communication to a database 180; and creating a profile of searched terms to optimize or reject future served advertisements based on known behaviors and associated keywords and phrases 182.

### Method of Migrating Search Users to Alternate Search Engine

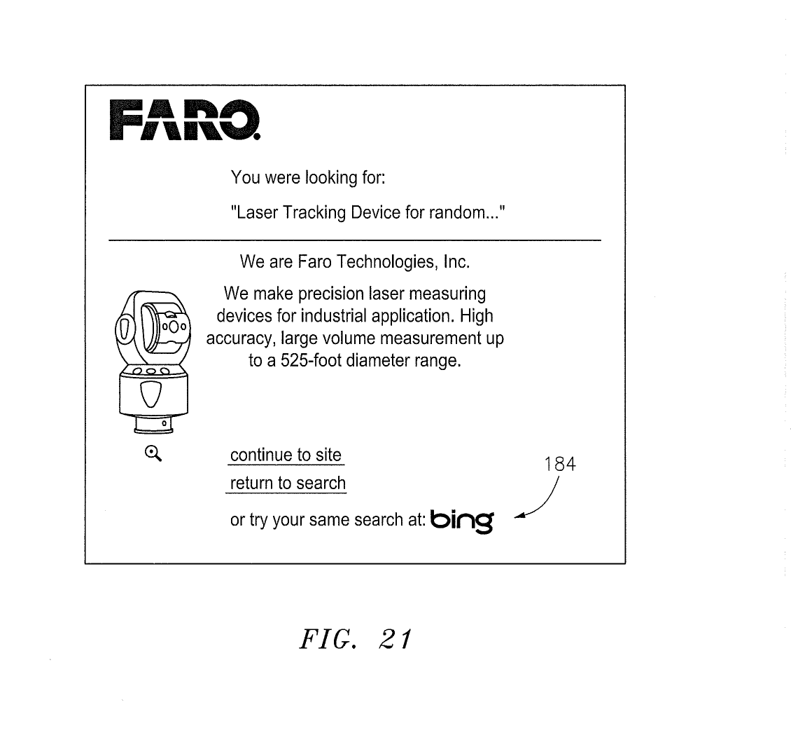

Other exemplary embodiments provide a method of migrating a search user from one search engine company to another and remunerating the pay per click transaction, e.g., where: the user searched term is parsed from the originating search; a link is created that parses and passes the user search term onto another site; an advertiser's paid searched term may be used when no parsed term is available; a link may be used to return a user to the originating search company with a new search instance or an alternate search company for remuneration; the return link can present the user with a target URL image; the user is presented with one or more alternative search companies as an offer; a browser instance is created as a pop up, pop in or pop under when a user hits the doorman; a request is made to the user to change the preferred search engine in a browser based on the selected alternative search engine request; remuneration occurs whenever a term is passed to the originating search company or alternative search company including, pay per click, pay per acquisition or any pay per action attributable to the new session; remuneration occurs in the form of a credit; remuneration occurs and the advertiser is not charged for any traffic that in may receive on the targeted search engine directly or during a specified time or number of clicks; remuneration occur based on the quality and behavior of traffic on the searched website; and/or remuneration is tied to total revenue for a user session on the targeted alternative search engine or originating search engine. FIG. 21 illustrates an exemplary doorman with a search engine migration button 184.

### Other Exemplary Uses for a Doorman

Various exemplary embodiments of a doorman have been described as being primarily developed as an anti-fraud tool and click validity tool. However, there are significant benefits of a doorman for the enhancement of sales in the commercial Internet environment. Numerous equivalents in classical commercial environments exist.

Examples such are the greeters at various stores that welcome a shopper and direct that shopper efficiently to their area of interest. The home page of many websites are formidable barriers to entry, much like superstores without such greeters, where efficiently finding what is needed is a difficult or difficult task.

In the case of various exemplary embodiments of the presently described doorman, the doorman may immediately be aware of incoming search keywords that resulted in the click. Thus, an exemplary doorman can present a company description and product picture most appropriate to the customer's interest, and in further exemplary embodiments provide a landing page other than the home page. Such exemplary embodiments place the visitor immediately on the site location of interest.

Exemplary embodiments of the doorman can also be enhanced with a video, flash, other formats or animated welcome, and can ask additional questions or provide an introduction to guide a visitor to a correct page with more specificity.

Various exemplary modes of pre-website interaction can significantly enhance the continuation and conversion rates by providing information, direction and user survey information, and can effectively give a user a soft landing to a page that provides an alignment of expectations specific to their needs.

### Pass Through Tracking Links

Exemplary embodiments also provide the ability to provide pass through tracking links from Ad>Doorman>Site, as an ability to parse any and all tracking code attached to a URL string that originates from any advertisement and to re-attach it for the continuation of that tracking after a behavioral set of data has been served and captured (by a doorman). This allows tracking to be fully functional after the doorman behavior has been captured and allows follow-on tracking to resume by any means, as originally intended had the doorman been presented or not presented through the service.

One exemplary embodiment takes any HTTP GET parameters that are sent with the request for a doorman (for example, in the illustrated exemplary doorman, these may be the ?a=b&c=d style parameters at the end of the link as seen on Google) and appends them to the URL generated such that they are sent to the target site when a user clicks to continue to the site. Effectively, in such exemplary embodiments, any such parameters that are part of the campaign target URL in Google (or any search) are passed through as part of the target URL from the doorman.

### Tracking of the Back Button

Another exemplary embodiment uses JavaScript code to track the time from when a user leaves a doorman by continuation to a Target and/or parsed tracking code and returns to the doorman by navigational means including the use of the back button. This exemplary functionality extends to repeat traffic through the advertising link as well to permit determination of double clicks and determination of the time delta and correlation of that data to behaviors on the doorman.

Once a user continues to the target URL, an exemplary embodiment provides a time stamp attributed to the clicking of the continue button. This may generate a unique cookie that is tied to the click record and a time stamp of that action. Upon detection of the browser navigation of the back button as the user clicks from the target URL associated with the doorman and returns to the doorman, the software recognizes the user and creates a record in the database that calculates the delta between to the event and records it as time on site and or linked pages.

### Mobile Devices, Applications and Embedded Content

In exemplary embodiments, the use of small touch screens makes mouse pointer accuracy incredibly difficult. It is not uncommon for users to accidentally click an advertisement due to the size restrictions of the touch screen and relative lack of control over closing functionality. Thus users may or may not set off a navigational event according to intent.

Accordingly, in exemplary embodiments, the present doorman functionality can extend to mobile devices and mobile applications and their advertisements, as well as embedded content such as the advertisements that are presented overlaying content on YouTube and other sites. In such formats, the delivery can consist of a simple delivery of the doorman, whereby the user is presented with an explanation that they have clicked on a paid advertisement and asked to verify that they intended to complete navigation or return to the previous screen. Additionally, content can simply request that a user confirm that this was their intent.

Thus, the present invention advantageously avoids prior problems with preventing click fraud and unintended or invalid clicks from these advertisements. In exemplary embodiments, such system uses compiled data to determine identify multiple click transactions from and a single user, which data may be compared against other data from the compilation of the two disparate sources and clicks in aggregate. Further, exemplary embodiments of the present invention facilitate assignment of a disparity score of a purchased keyword versus delivered search keyword(s) phrases and associations made including synonyms. Other exemplary embodiments provide for the use of the collected information to establish affiliate relationships between two parties, where the click is the transaction event and the event payment is determined by the actions of the delivery of the click, and the behavior on site determines and qualifies the amount to be paid for the transaction. This includes a gradient of payment to be made based on the Match Quality Score where percentages determine the total amount to be paid from a baseline number.

Other exemplary embodiments provide for the use of recorded behavioral actions on a site from an original keyword searched to determine algorithmically the relevancy of the search term to the landing page and subsequent ranking of the site for future search results. As was noted above, exemplary embodiments also provide for the use of a browser based JavaScript code to report back page views and time on site, allowing correlating of that data back to a singular keyword/click of origin. This data is reported back to the database prior to the user closing the browser, utilizing browser navigation or other native available actions.

Further, exemplary embodiments provide for use of data collected to tie back that information to determine the quality of the referring site to the landing site from origin source. In other exemplary embodiments, a paid keyword is compared against associated keywords or words to determine a relevancy for the determination of validity and value of a search transaction.

In other exemplary embodiments, the time on site and attribute to an individual of a user on a landing page and subsequent pages are tracked and tied back to a singular click transaction. Further exemplary embodiments provide for activation of a doorman interstitial, which is populated with search disparity information and activated by conditions set by the destination URL vendor, which provides a final defense against Search Engine Company caused disparity-fraud, robotic clicking and other nefarious activity.

Embodiments of the present invention also provide the ability to track time on a doorman/interstitial prior to action by a user or bot and to correlate that action and time to the choice presented and linking that information to continued destination URL activity and transaction record. Other exemplary embodiments provide the ability to repopulate the original search term for monetization after the traffic has been paid for once the doorman has been displayed.

### Click Variable Value Related Pricing for Improved Click Remuneration

Other exemplary embodiments provide for an improved method for remuneration in pay per click transactions, where the determinant for the cost of the click is not isolated to a single user action but a series of actions that are classified in the transaction process and have values associated with each action. PPC has become the dominant means of advertising on the Internet, but has been unable to exact any variation on the value of actions attributable to the transaction. Exemplary systems and methods provide for tracking that does not calculate the total cost per click until a series of automated and user defined actions take place that accurately represent the fair market value of the click transaction between an advertiser and publisher, e.g., for Internet and mobile devices, among others, by monitoring the clicking on an advertisement where: the click is recorded and attributed to the user and has some initial attributable value and the user is presented with a confirmation that they intended to click: where the confirmation of the click has an attributable value; where the repeated actions by a single user have an attributable value; where the physical location of the user at the time of ad delivery has a attributable value; where the referring URL is considered part of the transaction and has an attributable value; where the disparity between the searched term and paid term have a score and resulting value attributable to that scoring method; where the rejection of the click has an attributable value; where the amount of time that the user makes to make a qualified decision also has an attributable value; where the delivery of content in whole or in part has an attributable value; where the final delivery to the site in conjunction to the above methods of calculation of value determine the final cost per click; and/or where any actions and time on site or application have an attributable value when communicated through a unique user ID and communicated on a per transaction basis to the user.

In exemplary embodiments, the publisher and advertiser can agree to all or part of the above criteria and value accordingly to determine the total value of the click transaction on a per click basis/per transaction basis, e.g., where the publisher and advertiser are contractually obligated to the criteria for settlement of the transaction.

In other exemplary embodiments, a method for identifying and filtering bot and or automated traffic through the use of the Doorman is described. The method comprises several ways to both identify and filter the traffic through paid and unpaid placements online. Almost half of the traffic online is generated by automated means for the purpose of indexing through the use of spiders, crawlers and bots and generating revenue through automated clicking of paid placements for monetary gain. This is a tool that redirects invalid behavior away from valid users by use of the Doorman for the purpose of identifying fraudulent traffic. In exemplary embodiments, the method uses strategically placed links on the Doorman that attracts clicks from automated clicks and separates them from valid user actions. In an exemplary implementation, this is accomplished:
a. Where the Doorman is served to the user from an advertisement with the content intact.
b. Where the Doorman has links native to the Doorman that include additional links that are obfuscated to a valid user but appear to be valid to automated click bots and other automated traffic software;
c. Where these links may be textual, images and other types that may be served statically or dynamically based on known and unknown click behaviors;
d. Where text links contain the original search term from the click and images may contain alt tags that use those terms;
e. Where the number of links are fixed or varied;
f. Where the placement of the valid and invalid links may vary within the rendered code;
g. Where the text links appear camouflaged from a valid user;
h. Where the image varies in both size and color to appear camouflaged from the user to negate inadvertent clicks;
i. Where the links are indiscernible between valid and invalid clicks
j. Where the target URL on the invalid clicks are the same or different than the valid links;
k. Where the clicking on any of the invalid links on the Doorman results in flagging that click transaction and logging information, and that information is used to negate payment on the paid click transaction;
l. Where the information is used to create feedback to a database that includes known IP address, User agent, Time of Day etc.; and
m. Where data is applied to other keywords advertisers and networks to identify invalid behavior.

In other exemplary embodiments, a behavioral scoring process is used to quantify the behavioral quality of clicks singularly and in aggregate based on known variables from the click and/or interaction with the Doorman. Where applicable, site behavior may also be used as a determinant of value.

A normalized behavioral score can be created at a click transaction level but other inputs from any PureClick may also be used as a determinant to the scoring method. Examples of this may include similar campaigns from other advertisers, other keyword behaviors, and networks such as Google, Facebook, Bing and Yahoo.

Exemplary Implementation: This is a multi-stage process. The initial score that is native to the click transaction that can be calculated based exclusively on the information native to that click and the second stage is the information that can be calculated when analyzing at a later date from a network level down to a specific keyword across all values and advertisers. This calculation may or may not effect the initial scoring at the click transaction level.

Variables:

The following variables may be used to quantify the values of the behavioral scoring engine.

Referring URL

IP Address

Unique User ID

Account Re-user Visitation

Session Information

Time of Day

Bot ID

Parsed Keyword

Relevance Quality Score

Type of Partner
n. Basic
o. Search
p. Affiliate

Type of Link
q. Image
r. Text

Time on Doorman
s. With corresponding action

Actions on Doorman
t. Continue
u. Return
v. Multi Media interaction
w. Browser Back Button
x. Closing Browser
y. Repetitive Visitation to Doorman
z. Survey

Revisit the Doorman
aa. Action
bb. Time

Individual Scoring Implementation:

Score for a Referring URL: A score is based upon the click where a referring URL is present for the click transaction.

Applied:

IP Address: A score for an IP address based on click transactions and quality of clicks from that IP address and frequency of clicks from that address.

An exemplary ideal behavioral scoring is described:
1. Type in a keyword to a search engine
2. Click on a relevant advertisement
3. RQS created
4. Land on the Doorman and make a judgment about the relevancy
5. Spend normal time to make decision
6. View the content and choose to continue to the site
7. No revisit of the Doorman

### Null Value Behavioral Score

1. Bot ID'd clicks
2. No recorded time on Doorman
3. No referring URL present (search)
4. Repeated visitation within 5 seconds of previous click

### Nominal Value Behavioral Score

1. All values of Ideal User, and non-continue action
2. All values of Ideal User and less than X seconds to continue
3. All values of Ideal User and greater than X seconds to continue
4. All values on Ideal User but poor RQS
5. All values of Ideal User but less than X seconds on site
6. All Values of ideal user, but repetitive clicks
7. Alternant search selected

### Good Value Behavioral Score

1. All values of Ideal User and continue
2. All values of Ideal User with time on Doorman within a range of X to X seconds
3. No repetition of clicks
4. High RQS and all content viewed, including multimedia and continue
5. Alternant search selected

An exemplary alternate organic search pay per click model is also described:

The use of a divergent path of search results where one path is strictly commercial and the other is either all organic or a hybrid of organic and commercial results, in an exemplary embodiment, where;
Mmm The user decides what type of results are desired:
The results are based on the user searched phrase;
The commercial results are based on the Relevance Quality Score (RQS) between the search terms and the paid terms;
The order is based on a on this scoring method;
Payment is made by a tiered system for paid placement;
The rankings may be effected by known behaviors of the users;
Advertisers may pay to augment their relevancy by purchasing associated keywords, including but in no way limited to other paid keywords that they have purchased;

The entry and pre-population of the search term in the browser field shows additional terms most commonly purchased by advertisers based on user keyed values;

If RQS drops below an adjustable value, results are not shown;
Rankings are tied to aggregated user behaviors based on responses
The results may be localized;
The searched results may be filtered based on user defined values such as geography, business type (franchisee, mom and pop, minority owned, languages, small business, non for profits and other advertiser defined variables);
The results can be displayed by a randomized order between the tiers;
User Behavior Score provides feedback to search results based on other user experiences with exact or similar terms; and
Charges are only administered if a user validates the click path by continuance to the target site.

An improved exemplary method of commercial search is also described, wherein

search affiliates and sites with specialized products focus provide a useful commercial purpose. In this improved commercial search pay per click model search affiliates qualify themselves from a library of keyword relevant to the affiliatate's category.

A method is described for deployment and recordation of Action and Time to Action for the Doorman for Mobile, Tablet and other Computer Devices. Web browsers and carriers limit the total available bandwidth for mobile devices and in doing so restrict the capabilities of tracking user behaviors on network devices. Common functions, like Javascript tend to require higher bandwidth and processing power to function properly and within time and bandwidth constraints of networks and devices.

An exemplary embodiment uses a different script than Javascript. An improved method for measuring time on a Doorman and the action attributable to the User is the use of one or more redirect, where:
1. The click creates a transaction from external PPC link is created and the Doorman may or may not be served but a transaction record is created;
2. The type of device is detected by the user agent or other methods;
3. The size and content of the Doorman is dynamically generated by and served to the device based on available information determined from the device;
4. The user options on the Doorman (ex. Continue button or link, and or return to preceding page) are links presented to the user along with other content;
5. Other links may be served that serve as filter to automated traffic protection;
6. Multiple choices have different redirected URL's or are differentiated based on other methods;
7. The user clicks on the choice and is redirected to internal or external servers and the alternate click is recorded where;
   a. Another transaction record constituting a click action that is tied to the originating click transaction (1 above);
   b. With a time date stamp attributed to the click/user action from options presented (a above);
   c. The time date stamp is compared and deducted or added to the transaction record from the initial click transaction and creates a time on the Doorman value and attributed to the action recorded on redirected URU's;
   d. Where the return link negates the PPC cost to the advertiser in the form of a credit or other methods;
   e. Where the use of a “continue” or other similar button validates and or time to action can value and validate the originating PPC cost and/or value the transaction differently.

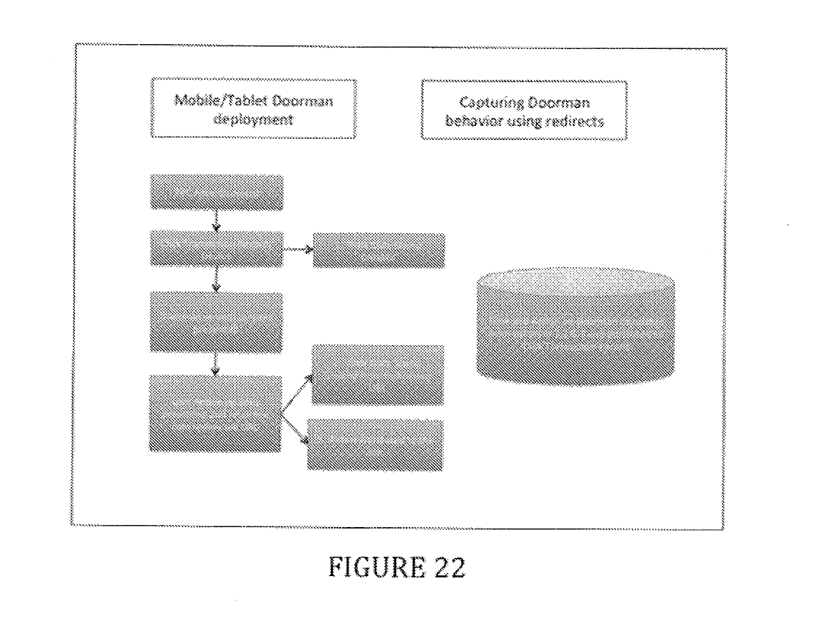

Reference is made to FIG. 22, which illustrates an exemplary mobile doorman deployment.

In another exemplary embodiment, the system analyzes search company impression relevance behavior using search query terms from paid clicks only with or without the knowledge of all advertisers paid keywords. The exemplary embodiment determines the quality of the search company's placement of an advertiser PPC ad h on the use of a RQS relevance quality score, which is a numerically determined value derived from the alphanumeric comparison between the paid keyword associated with a PPC ad and the search term entered by the search user. This data is captured using an interstitial website and various intelligent and dynamic tools to capture the relevant PPC data and the search user's response thereto.

An exemplary embodiment is a method to garner relevance quality data to a high degree of accuracy from past data before implementation of the interstitial.

The simplest features of historic phone bills specifying call number and minutes with the associated cost are non-existent in the world of PPC advertising. This lack of transparency may obfuscate the practice of search engine PPC ad impression relevance. Thus the relevance between the search user search query terms and the paid keywords for the PPC ad may not be proportional. The higher the disparity or the lower the relevance quality the more often a PPC ad will be presented and the more likely that it will be clicked by a search user who assumes it is relevant when it is not.

In an exemplary embodiment, a relevance quality scale from 0 to 100, where a relevance quality of 100 is an exact match between the search query term and the paid keyword, is described. In such embodiment, search user corroboration of the doorman interrogation has confirmed that relevance quality scores below 70% result in lower continuation rates.

Advertisers with extensive advertising history with PPC ads have substantial data available from the search company's analytics database. The lack of unique transactional data and relevance quality presents a significant barrier to determine if the search company is not accurate in the PPC ad impressions. In addition there is no report to list the keywords that were active at the time of the PPC, for which a search query term is relevant. This makes it very difficult for the advertiser to determine if the ad was reasonably placed.

An analytics feature allows the advertiser to review certain demographic and click source data and user behavior on an aggregated basis and not on transaction basis. In addition a report, which may be called a search query report, provides a list of all the search users search query terms used that resulted in a pay per click transaction.

Accordingly, an exemplary method for the determination of likely paid keywords and the calculation of relevance quality scores for each search query term gives the search engine company the benefit of the doubt in all RQS calculations and provides a report describing the search company's “best case” PPC ad impression relevance behavior.

In an exemplary method:
1. The search query report (SQR) is run on the search engine analytics platform and downloaded in a comma delimited format or any other common data format.
2. The SQR data is uploaded to a software program which is the embodiment of this invention, which performs the following tasks:
   a) The SQR data is analyzed for the most common recurring words. The most commonly recurring words are presented on a list as the most “likely paid keywords” synonyms, misspellings and other potentially relevant terms.
   b) The Advertiser is presented with a user interface permitting them to verify which of the potentially relevant terms are indeed relevant.
   c) Alternatively the advertiser may directly upload a separate file of paid keywords and/or synonyms and common misspellings of paid keywords.
   d) Each search query term is quality matched to the list of Paid keyword and the search query term is assigned the relevance quality score of the highest resulting score.
   e) The relevance quality score may be calculated to include the other remaining keywords in order to give the Search company the greatest benefit of the doubt. Although this is not what is done by the search company in determining the ad placement.
3. The software then generates a relevance quality report providing the number of search query terms or paid clicks for specific ranges of relevance quality scores.
4. The advertiser may then choose to produce a refund report demanding refund from the search company for clicks with relevance quality scores below a certain threshold acceptable to the advertiser. The refund report lists the search query terms by transaction allowing the search company to determine the specific click transactions to be credited and the appropriate credit due to the advertiser.

In another exemplary implementation, an automated doorman relevance analysis of historical PPC advertisement transaction data is performed:L

The present disclosure recognizes that automated historical data evaluation of PPC transactional records using the Doorman interrogation approach on an after-the-fact basis may be important in the evaluation of Search company ad placement behavior and the optimization of advertising campaigns.

The historical data is available from search company transactional reports such as they are for both paid search in the form of Search Query Reports (SQR) and in Display networks with affiliates in the form of a placement report. The SQR provide a detailed listing of the search query term entered by a search/user and the paid keyword which resulted in the ad display. This data can be analyzed as in a search user simulation using a doorman or by an automated relevance scoring methodology as described above. The nature of this invention as discussed above is around the concept the relevance of the search company ad placement whether in Paid search or affiliate display network must be confirmed by the search user and/or the advertiser to determine their legitimacy because of the important conflict of interest that exists between the determination of relevance by the search company and the revenues derived from placements which depend on that relevance.

Methodologies are slightly different for paid search ads versus affiliate display ads but in both cases historical data can be analyzed by the advertiser in the equivalent of a manual or automated Doorman relevance analysis.

In an exemplary case of the paid search, the search query report is uploaded to a relevance analysis program which automates the doorman relevance analysis process described in the above.

In one exemplary embodiment: The Dynamic configuration is accomplished after an automated review of the data in the incoming click stream.
1. The analysis of the incoming data stream includes the determination of a relevance score.
2. The analysis of a known referring URL singularly or in conjunction with other attributes
3. The analysis of other click stream data known to be associated with click fraud

Exemplary features of the automated Doorman analysis of relevance in historical data include the uploading of the search query data. That report data may be processed to extract search terms and keywords. This process provides the ability of stemming the search terms and building a reference library of advertiser paid keywords. The relevance data to simulate the assessment of relevance by a search user through the real time manual use of the doorman may be performed in an automated process. The various data forms can also be analyzed

The click data database can be used to provide a variety of reports beneficial to the SE/Corp and the Target URL advertiser.
1. A credit report for claiming refunds from the SE/Corp for fraudulent clicks.
2. The quality of the certain keyword in terms of their continuation rates at the Doorman.
3. A list of the most successful referring URLs to allow the Target PPC advertiser to establish direct advertising relationships and eliminate the SE/corp from the process.
4. The quantity and type of bot traffic.
5. Keyword quality.
6. URL quality scores.

In the case of affiliate display ads, where no search term is specifically entered, the search company may determine relevant affiliate sites on which to display ads. In this case the automated doorman interrogation of relevance is more difficult and requires the use of a re-simulation of the placement on the affiliate publishing site. In the case of display, the required report for historical analysis is the placement report which lists the affiliate websites among other transactional data. The automated doorman interrogation then may aggregate the affiliate sites according to advertiser specified criteria and presents the affiliate sites in a specific order for a relevance evaluation by the advertiser. In this manner thousands of sites can be quickly grouped, sorted and assessed for inclusion or exclusion in the advertisers affiliate publishing sites.

Another exemplary embodiment describes a method that compiles transactional information from advertisers, publishers and users and enables an interface, which allows the advertiser to determine relevancy of the placement based on the activity of the user and publisher information. The use of filters to aggregate information in a meaningful way based on what is relevant to the advertiser may be determined based on the following criteria:
a. Mmm Placement URL
b. Cost per click
c. Average cost per click
d. Number of impressions
e. Total clicks
f. Numbers of conversions
g. Types of advertisements (text, image, etc.)
h. Total cost
i. Domain name and type
j. Types of devices where ad was served (mobile, application, desktop, etc.)
k. others

An exemplary method is also described to aggregate the information from an internal of external source either through a imported file (such as a .csv), API or other method for the purposes of displaying a voting interface where:
The placement is voted upon based on the advertisers relevancy determination
The placements are tallied based on any or all of the above filters;
The accepted and rejected scores are compiled to determine a ratio for the originating placement and domain;
The monetary cost of a placement is counted in aggregate;
The placements are counted in aggregate for a single file, multiple files or a network;
The total scores can be combined in aggregate from one or multiple advertisers to determine the quality of the domain and/or placement to help determine the quality of a publisher;
The rejected sites can be blocked from future business;
The accepted sites can be directly managed through the voting process and bids managed based on the advertisers opinion of the site; and
A modifier that can adjust a blocked site to an accepted site based on a relevancy score.

A display of the originating site can be done through an iFrame, a screen shot that is stored and then served, including a copy of the ad or image is displayed with the site, or other method where the relevancy can accurately be assimilated to the original publisher placement and context of the delivery of an advertisement to the user. When permissible, a screen shot is archived at the point of delivery of an advertisement on a publisher's site and user interaction, such as a click from a user and stored at the point to show the contextual placement of the delivery for later review. This can allow an advertiser to see other relevant advertisements and the 1 content at the time of the transaction to vote on the relevancy of the placement.

In another exemplary embodiment, an advertiser can select and deselect relevant placements by simply tuning a numerical or other relevancy tolerance indication that they are willing to accept at any given time. Example: An online shopping mall may want to loosen up relevancy during a holiday season because it may find that the everyone is relevant to their objective, whereas a Team Sport site may not want to advertise during that time and tune relevancy threshold to its highest practical level.

In another exemplary embodiment, a method for distinguishing between valid and invalid click traffic is provided to identify well intended traffic through the use of advanced filtration techniques on the Doorman. However, automated traffic exists that can circumvent this method of validation. The present exemplary techniques are methods for isolating valid users from invalid users through content on the Doorman as well as being delivery methods of that content and its variants. This exemplary method further isolates valid clicks from invalid clicks while measuring and resolving clicks in a PPC relationships with a very simple rendering of the Doorman that can be deployed via Advertiser Agent, Advertiser Sub Domain, Advertiser hosted solutions and via API's.

Part of the issue in the prior art is that almost half of the traffic online is generated by automated means through the use of spiders, crawlers and bots. While some of these traffic sources are benign, there is a growing number designed to generate revenue through automated clicking of paid placements for monetary gain to the Publisher or Publisher Agents, directly and indirectly. Without the ability to have click resolution beyond the action taken on the advertisement, it is difficult to measure, with any degree of accuracy, whether a user is valid or invalid. While some methods, such as tracking a mouse cursor on a screen, do exist as well as other publicized methods, the increasing rise of mobile devices makes this technique obsolete.

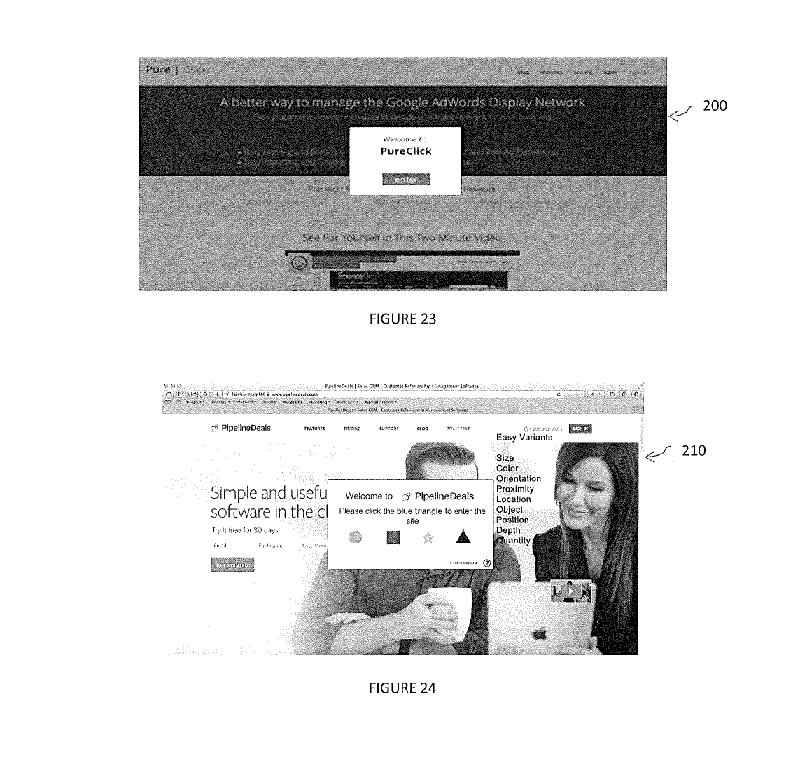

This exemplary method uses strategically placed links and other methods to challenge the incoming click to determine validity of the user. It is uniquely effective in this task because it creates the lowest barrier for continuation to the target URL by a legitimate user. Conversely, the complexity to automated traffic sources is maximized to remove even the most sophisticated automated or bot traffic from a variety of sources. While the traditional features on the Doorman can still be employed, FIG. 23 represents a simplified rendering of the Doorman generally at 200. The presently described exemplary embodiment provides a method where the action on the simplified Doorman may be recorded with any or all of the following actions:

| Action | Description |
|---|---|
| CONTINUE | The User clicked the continue button in the Doorman to |
| | go to the target site. |
| RETURN | The User clicked the return button in the Doorman to go |
| | back to the referring URL. |
| BACK | The User used the Back Button in the browser to |
| | navigate away |
| NAV_AWAY | Indicates that the “unload” javascript logic |
| | in the page was executed successfully, but the User |
| | navigated away in an indeterminate fashion. |
| VIEWED | Indicates that the Doorman loaded far enough to record a |
| | HEARTBEAT fingerprint, but no other final action was |
| | observed |

Another exemplary embodiment provides a method where a series of actions, individually or collectively, are recorded while the browser interacts with the Doorman. This fingerprinting method for the actions completed can be broken down into two categories that apply to all standard browsers as well as browser specific fingerprints that record actions specific to a browser type and version. Additionally they consist of, but are not limited to, invalid fingerprints, incomplete fingerprints and invalid http headers described below. This is measured for the purpose of differentiating between valid and invalid users. Methods of detection include, but are not limited to, the following actions and detection methods:

| Action Name | Description |
|---|---|
| HEARTBEAT | Javascript in the page sends a “heartbeat” request every 3 seconds, |
| | which also sets the doorman_action to VIEWED(6) if there is no |
| | other action. Set if at least one heartbeat was recorded for the click. |
| HEARTBEAT_BACK | On page load, a special script tries to determine if the browser has |
| | reloaded the page after bitting the back button from the target URL, |
| | based on a javascript value persisting from the original view of the |
| | doorman. This would normally only occur if a browser hit the |
| | “Continue to Site” button, and then used the back button to return to |
| | the doorman. Not all browsers demonstrate this behavior |
| ACTION_BUTTONS_JS | Recorded if the browser clicks the “Continue to Site” to “Return to |
| | search” buttons with javascript enabled (action = 1 or 2) |
| ACTION_BUTTONS_NOSCRIPT | Recorded if the browser clicks the continue/return buttons in the |
| | <noscript> section, i.e with javascript disabled (action = 1 or 2) |
| ACTION_NAV_BACK | Recorded if the browser leaves the Doorman via the back button |
| | (action = 3) |
| ACTION_NAV_AWAY | Recorded if the browser unloads the page in an indeterminate fashion |
| | (action = 4) |
| IMG_LOGO | The browser requested the logo for the link |
| IMG_JS_SIMPLE | Javascript in the watchman inserts an <img> tag into the page using |
| | document.write( ). If the browser requests that image, this bit is set |
| IMG_JS_OBFUSCATED | A document.write( ) <img> tag where the javascript has been |
| | obfuscated such that a simple pattern match on the page looking for |
| | URLs will not match it. |
| IMG_NOSCRIPT | An <img> tag inside a <noscript> section. |
| IMG_CSS | An image referenced inside a CSS style used in the watchman |
| IMG_CSS_UNUSED | An image reference inside an unused CSS style |
| CSS_IMPORT_PRE | Recorded if the browser requests a stylesheet referenced in a CSS |
| | @import statement which occurs at the top of a <style> section |
| CSS_IMPORT_POST | Recorded if the browser requests a stylesheet referenced in a CSS |
| | @import statement which occurs at the end of a <style> section |
| BOMB_LINK | Recorded if the browser follows a link inside an invisible section of |
| | the page. |
| BOMB_BACKDROP | Recorded if the browser follows a link in the backdrop that is not |
| | clickable due to the watchman overlay |

In exemplary embodiments, an invalid fingerprint is a fingerprint that records a set of actions which are either mutually incompatible, do not naturally occur for the browser identified by the User Agent for the Click User, or are incompatible with other properties of the click. The following fingerprint scenarios are filtered include but are not limited to the following:

IMG_NOSCRIPT and (IMG_JS_SIMPLE or IMG_JS_OBFUSCATED
or ACTION_BUTTONS_JS)
ACTION_BUTTONS_NOSCRIPT and (IMG_JS_SIMPLE or
IMG_JS_OBFUSCATED or ACTION_BUTTONS_JS)
IMG_NOSCRIPT or ACTION_BUTTONS_NOSCRIPT for ads that
require javascript (Display)
IMG_JS_SIMPLE but not IMG_JS_OBFUSCATED
CSS_IMPORT_PRE and CSS_IMPORT_POST (except for Opera
versions 12 and earlier)
IMG_CSS and IMG_CSS_UNUSED
HEARTBEAT_BACK but not ACTION_BUTTONS_JS
Missing HEARTBEAT but a Click action of NAV_AWAY, BACK,
RETURN, or CONTINUE with a Click time of greater than 3 seconds

An incomplete fingerprint is a Click for which not all of the actions are received that are normally expected for a web browser. A fingerprint that indicates the page loaded completely includes at minimum, for browsers with Javascript enabled, includes but is not limited to the following:

HEARTBEAT
IMG_LOGO
IMG_JS_SIMPLE
IMG_JS_OBFUSCATED
IMG_CSS
CSS_IMPORT_PRE

Or, if the Link is not used for an Ad that requires Javascript, alternatively at minimum:

IMG_LOGO
IMG_NOSCRIPT
IMG_CSS
CSS_IMPORT_PRE

In exemplary embodiments, if the Click originates with a non-mobile device (determined via User Agent), then it also records a final action other than VIEWED. If these conditions are not satisfied, then the Click is considered to have an incomplete fingerprint and is filtered

In other exemplary embodiments, if any of the following conditions is true, then the Click will be filtered as invalid.
Missing ACCEPT header.
X-REQUESTED-WITH header indicating android mobile device but non-android User Agent
X-Forwarded-For: localhost (127.0.0.1)

These conditions correspond to patterns seen from bot behavior detected in the advertising ecosystem.

In other exemplary embodiments, a method is provided where the continue button to the target URL on the Doorman is generated dynamically or statically when it is requested by the browser; and the user interaction with the button determine validity or invalidity of the user. This may include with a hyperlink, graphic, script or other rendering methods to display a call to action to a legitimate user.

The shape of the button may vary based on the browser request. The content of the button may vary based on the browser request. The position of that button may vary or be randomized based on the browser request. The size of the button may vary based on the browser request. The color of the button may vary based on the browser request. The button may move dynamically while being served. The button may be time limited in functionality

In exemplary embodiments, one or more buttons may coexist on the same Doorman. Also, a series of sequential choices may be used to validate or invalidate a user. Additionally, a time on the Doorman may be used to invalidate the click. Further, a lack of time registered on the Doorman may be used to invalidate the click. Also, the target button may move while being rendered or by other methods.

In other exemplary embodiments, a method is provided where a Doorman image is generated dynamically when it is requested by the browser and is determined randomly. The coordinates of the placement of the button are stored in the coordinates field or other location or similarly functioning method. Using a javascript click event handler or other methods, all clicks inside the border of the Doorman image are captured and submitted to the Doorman service using an ajax request or other method, which includes the coordinates where the click occurred inside the box. These clicks are recorded in the Doorman table or other location. If the coordinates of the click are inside the coordinates of the generated enter button or similar link, then the click is registered as a continuation and validated. The success or failure of the click is returned from the ajax request or other method. A successful click triggers the browser to submit a request to continue on to the Target URL. An unsuccessful click is also recorded and no action is taken. The method of deployment of this Doorman may employ one or more of the exemplary following methods, including”: varying the shape of the button based on the browser request; varying the content of the button based on the browser request; varying the position of that button or randomizing it based on the browser request; varying the size of the button based on the browser request; varying the color of the button based on the browser request; moving the button dynamically while being served; time limiting the button in functionality.

In other exemplary embodiments, one or more buttons may coexist on the same Doorman. Further, a series of sequential choices may be used to validate or invalidate a user. Additionally, a calculation may be employed to determine the relative distance between the invalid and valid click. Also, a time over certain value on the Doorman may be used to invalidate the click. Further, a lack of time under a certain value registered on the Doorman may be used to invalidate the click/user. Also, coordinates of an invalid click attempt may invalidate the user. The coordinates of measuring a valid click may also change over time.

An additional exemplary embodiment provides a 1-click puzzle based Chaptcha for PPC or general site security. The current markets in Captcha's, which are designed to stop robotic traffic, are generally characterized by the analysis of an image followed by the entry of a number of text characters. Other examples include a prompt to enter a marketing phrase. In all cases, there are no Captcha currently in the market that simply require a single click to verify that the user is a human and not a bot.

In previously described exemplary embodiments, a moving target click area with variable locations and attributes were described. The following disclosure of exemplary embodiments is differentiated by a new anti-Robotic concept which is the combination of a text prompt followed by graphical target array. Only one member of the graphical target array is the correct response to the text prompt. In effect this is a simple human cognitive puzzle requiring the simple understanding of a text prompt and the 1-click selection of the correct answer. The infinite variety of text prompts and colloquial language use in addition to an infinite set of possible graphic motifs and locations creates a significant barrier to Robotic analysis. However, repeating any puzzle arrangement will be prone to possible reverse engineering. Hence a second concept is introduced called High-Frequency Vertically-Dense presentation which seeks to eliminate any possibility of a Captcha being reverse engineered.

High Frequency refers to the changing of the puzzle in any presentation session (intra-session) and between successive sessions (inter-session). Intra-session a robotic program would try to capture and reverse engineer the 1-click puzzle, but if the Puzzle changes in the session at some random rate while awaiting the click the Robotic analysis would return an incorrect answer while a human would easily adapt and respond to the change. The intra-session change can be subtle so as not to be too challenging or jarring to the user.

The Inter-session change means that on successive entries to a website the Captcha would change sufficiently so that any robotic analysis would not discern a pattern which could be reverse engineered. Since there an infinite number of motifs or puzzle types this can be easily achieved.

The principle of the 1-click Captcha being used as an interrogatory of a user for pay per click advertising and other protective deployments has been described. A decision based question or request is presented to the user that relates to specific variable also contemplated in the 1-click Captcha and the challenge must meet the required object in the described interrogatory. The variability in the request and the variability of the correct response given all the combinations makes it exceeding difficult for a bot to navigate compared to traditional Captchas.

Further advances in the technical implementation of the 1-click Captcha introduce adding variability of the interrogatory in a manner that the semantics of language make it very difficult for a bot to translate or equate the correct response but very easy for a human. There are multiple deployments of the interrogatory and subsequent correct responses to the challenge. Methods include, but are not limited to words, symbols and qualifiers described, and are exemplified but not limited to, the following and examples in bold:
a descriptive term of the correct response
   ex. Click on the green triangle
a descriptive term that implies the correct response
   ex. Click on the upside down image
a descriptive term that excludes all but the correct response
   ex. Do not click on the two on the right
a descriptive term where the sequence of the terms is modified and done in a way to randomize the pattern but still be interpretable.
   ex. There is a triangle that is blue, please click on it
A series of variables and descriptions described in combination in the interrogatory that further specify or distinguish the correct response
   ex. Please click on the (blue), (upside down), (triangle)

Further advantages of the technical implementation of the 1-click Captcha include adding variability to the selections required to pass the challenge response. The objects include things such as previously described and the following exemplary methods (reference is made to FIG. 24, shown generally at 210:
Size
   ex. Interrogatory terms smallest, largest, greatest, littlest, etc
Color
   ex. Interrogatory terms red, striped, dotted, green, black, etc.
Orientation
   ex. Interrogatory terms, upside down, right side up, sideways, etc.
Proximity
   ex. Interrogatory terms closest, two next two each other
Location
   ex. Interrogatory terms right, left, middle, upper right, lower left
Relative Position
   ex. Interrogatory terms second, third from right, top most
Shape
   ex. Interrogatory terms circle, square, triangle, hexagon, cylinder, cone
Quantity
   ex. Interrogatory terms group containing three, four items
Repetitiveness
   ex. Interrogatory terms repeated terms, non-repeating terms
Symbols
   ex. Interrogatory terms rabbit, car, house, ball, dot.

The combination of semantics and obfuscation of the correct valid response in relation to the incorrect responses creates a challenge for any programmatic method of beating the security of the 1-click Captcha. The 1-click Captcha vertical variability can be dynamically generated, static or customized based on inbound characteristics of the users. The permutations and randomness between language and objects create an insurmountable barrier for computer driven programs and easy to use one click access by users.

It is further noted that exemplary embodiments may be embodied in the form of computer-implemented processes and apparatuses for practicing those processes. Therefore, according to an exemplary embodiment, the methodologies described hereinbefore may be implemented by a computer system or apparatus. Portions or the entirety of the methodologies described herein may be executed as instructions in a processor of the computer system. The computer system includes memory for storage of instructions and information, input device(s) for computer communication, and display device. Thus, the present invention may be implemented, in software, for example, as any suitable computer program on a computer system somewhat similar to computer system. For example, a program in accordance with the present invention may be a computer program product causing a computer to execute the exemplary methods described herein.

Therefore, embodiments can be embodied in the form of computer-implemented processes and apparatuses for practicing those processes on a computer program product. Embodiments include the computer program product as depicted in on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described example embodiments, including the best mode, and any detailed discussion of particular examples, are merely possible examples of implementations of example embodiments, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

1. A method for distinguishing between valid and invalid click traffic to identify well intended traffic, comprising a using non-transitory memory of a computer to institute a doorman and to filter to isolate valid users from invalid users through content and delivery of content on the doorman.

2. A method in accordance with claim 1, wherein valid clicks are isolated from invalid clicks with measuring and resolving clicks in a PPC relationship via rendering of the doorman.

3. A method in accordance with claim 2, wherein said doorman is deployed by Advertiser Agent, Advertiser Sub Domain, Advertiser hosted solutions or APIs.

4. A method in accordance with claim 2, comprising strategically placing links to challenge an incoming click to determine the validity of a user.

5. A method in accordance with claim 4, wherein user actions including continue, return, back, navigate away and viewed are recorded.

6. A method in accordance with claim 4, wherein a series of user actions are recorded while the browser interacts with the doorman.

7. A method in accordance with claim 6, wherein fingerprinting is used to record actions for standard browsers.

8. A method in accordance with claim 6, wherein fingerprinting is used to record actions for browser specific actions.

9. A method in accordance with claim 1, wherein a continue button to a target URL on the doorman is generated dynamically or statically when it is requested by a browser to determine validity or invalidity of a user based in user interaction.

10. A method in accordance with claim 9, wherein the shape, content, position, size, color, or time limit of the button varies based on the browser request.

11. A method in accordance with claim 1, wherein the doorman image is generated dynamically when requested by the browser and wherein the configuration is random.

12. A method in accordance with claim 11, wherein the random configuration involves the shape, content, position, size or color of the button.

13. A method in accordance with claim 11, wherein a calculation is employed to determine the relative distance between an invalid and a valid click.

14. A method in accordance with claim 11, wherein a time over certain value on the doorman is used to invalidate the click.

15. A method in accordance with claim 14, wherein applicable, site behavior may also be used as a determinant of value.

16. A method in accordance with claim 11, wherein coordinates of an invalid click attempt invalidates a user.

17. A method in accordance with claim 11, wherein coordinates of measuring a valid click change over time.

18. A method in accordance with claim 11, wherein a series of sequential choices are used to invalidate or validate a user.
